(19) United States
(12) Patent Application Publication
(10) Pub. No.: US 2014/0279625 A1
(43) Pub. Date: Sep. 18, 2014

(54) Social Network Based Skill Rating and Performance Feedback System

(71) Applicant: Louis Levine Carter, Palm Beach Gardens, FL (US)

(72) Inventor: Louis Levine Carter, Palm Beach Gardens, FL (US)

(21) Appl. No.: 14/216,750

(22) Filed: Mar. 17, 2014

Related U.S. Application Data
(60) Provisional application No. 61/801,794, filed on Mar. 15, 2013.

(51) Int. Cl. G06Q 50/00; G06Q 30/02

(52) U.S. Cl. CPC G06Q 50/01; G06Q 30/0282
USPC 705/319

(57) ABSTRACT

A social network based system is provided to facilitate a user to get the user's progressive ratings on skills over time in reference to concrete reference activity. The system comprises means for a user to build social network for facilitating skill-rating and means for creating a rating request defining a context activity and target skills. The system further comprises means for inviting users of different relationships to user from the user's social network to rate on target skills included in the rating request in reference to the context activity. The system further comprises means for answering an incoming rating request, through which 360-degree rating data over time can be provided on a rating request. The system further comprises means for establishing groups for facilitating skill-rating for organizations. Means are provided to create team rating request through which a group can collect team 360-degree rating data of members over time.

### CROSS-REFERENCE TO RELATED APPLICATION

This application claims the benefit under 35 U.S.C. §119(e) of Provisional Patent Application No. 61/801,794, filed Mar. 15, 2013, the entire disclosure of which is hereby incorporated by reference.

### BACKGROUND

1. Technical Field

The present disclosure generally relates to a performance feedback system. The present disclosure more particularly relates to a social network based skill rating and performance feedback system.

2. Description of the Related Art

Online skill-rating systems have been developed with the advent of Internet. However, conventional skill-rating systems have several major problems. First, conventional skill-rating systems, at least from a user's perspective, are not social network based. For example, a user, who knows best about the people best suited to provide feedback and ratings on the user's skills, cannot build a social network for the purpose of facilitating receiving feedbacks (on the user's skills) from those who are best suited to do so. As a result, with the conventional skill-rating systems, it is impossible for a user to build a social network of his or her own that facilitates the user to receive feedbacks and ratings from people who are best suited to do so. Second, conventional skill-rating systems are mostly designed to let a rater give ratings to a ratee on a pre-designated set of skill without giving the ratee an opportunity to define a context to which the rate hopes that the rater can reference (when giving the ratings). This yields the undesirable result that the ratings given by the rater are often too abstract for the ratee to appreciate or agree. Third, conventional skill-rating systems are simply not designed to track progress of a user on target skills over time in reference to a concrete and documentable context so as to use the documented and demonstrated progress of the user to encourage and motivate the user to make further improvement. Therefore, there is a need for a revolutionary skill-rating system and method that can address the above-noted deficiencies of conventional skill-rating systems.

### BRIEF SUMMARY

In one aspect, the present disclosure provides a skill rating and performance feedback system enabling a user to build the user's own social network to facilitate the user to receive skill-rating and performance feedback from people best suited to do so. In one embodiment, a user may proactively build the user's social network by, e.g., inviting people to become followers and/or raters and subsequently adding those who respond to the user's followers and/or raters. A user may also be timely informed of skill-rating related news of the user's social network. A user may post status updates and comments to skill-rating related news events of the user's social network, thus facilitating the user's communications with the user's social network on skill-rating related matters. All these capabilities greatly facilitate the user to timely receive feedback and ratings on target skills from those best suited to do so and have timely communications concerning received feedback and ratings on target skills, thereby greatly helping the user to make progress on target skills.

In another aspect, the present disclosure provides a skill rating and performance feedback system which enables a user to receive feedbacks and ratings on respective skills basing off of or otherwise linked to a specific used-for-skillrating reference activity or a series of related used-for-skillrating reference activities. With this activity-based approach, raters do not provide skill ratings and feedbacks in a vacuum, but instead provide skill ratings and feedbacks basing off of what the ratee has demonstrated in a concrete reference activity. This activity-based approach also facilitates a user to receive feedbacks and skill ratings from raters having different relationship with the user while basing off of the same reference activity when giving feedbacks and skill ratings, thus providing the user with a true multi-relationship 360-degree feedback basing off of a concrete reference activity. Also, a re-rating mechanism is provided to facilitate the user to receive a series of rounds of skill ratings in reference to a same reference activity at a series of successive points in time. With a series of rounds of feedbacks and skill ratings received on the same reference activity (which targets the same set of target skills) through the re-rating mechanism, or with feedbacks and skill ratings received on a series of related reference activities targeting the same set or similar sets of target skills, a user's progress on the targeted set(s) of skills over time can be readily tracked and demonstrated, thereby allowing the user's progress (made on the target skills) to be timely and regularly recognized by both the user and the user's relevant community (such as the user's peers and supervisors). This in turn encourages and motivates the user to make further improvements on the target skills, which creates beneficial cycles conducive to the user's professional growth.

In yet another aspect, the present disclosure provides a skill rating and performance feedback system which enables a user to create a group or team for facilitating the providing and receiving of feedbacks and ratings on a set of group (team) skills uniformly applicable to members of the group in an organizational environment. In particular, a group administrator may use “AnyTime 360-degree requests”, which are 360-degree team rating requests uniformly applicable to group members and tailored to the groups needs, to collect team 360-degree ratings. The collected team 360-degree ratings can then be used to track, document and demonstrate members' progress on targeted team skills made over time, thereby allowing the members' progress (made on the target group-skills tailored to the group/organization/team) to be timely and regularly recognized by both individual members and the leaders of the groups. This in turn encourages and motivates individual members to make further improvements on the target group-skills tailored to the group, which creates beneficial cycles conducive to individual members' professional growth.

In yet another aspect, the present disclosure provides a rating scheme that gives a rater an opportunity to provide appreciation and advice to a ratee together with the regular ratings of target skills. With the provided appreciation and advice, the ratee will feel appreciated while gaining better understanding on what needs to be improved, and will thus be less likely to become resistant to receiving feedbacks and skill ratings.

With at least these above-noted aspects, the disclosed skill-rating system revolutionizes a user's skill-rating experience, and effectively addresses notable problems of conventional skill-rating systems.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIGS. 1A-C are block diagrams illustrating an operating environment of the disclosed social network based skill rating and performance feedback system, the backend system thereof, as well as an exemplary client device used to access the backend system, in accordance with one or more embodiments of the present disclosure.

FIG. 2 shows block diagrams illustrating an exemplary implementation of DS 111 of the backend system, according to one or more embodiments of the present disclosure.

FIGS. 3A-B are block diagrams illustrating processing engine 121 of skill-rater module 112 of the backend system, according to one or more embodiments of the present disclosure.

FIGS. 4A-C are block diagrams illustrating data engine 122 of skill-rater module 112, according to one or more embodiments of the present disclosure.

FIGS. 5A-C are block diagrams illustrating display engine 123 of skill-rater module 112, according to one or more embodiments of the present disclosure.

FIGS. 6A-D are flowcharts exemplifying operational blocks (steps) used in the disclosed skill-rating system's handling of typical skill-rating related user requests, according to one or more embodiments of the present disclosure.

FIGS. 7A-D are pictorials illustrating exemplary UIs and custom processing steps which the disclosed skill-rating system provides to implement user sign-up (registration) and sign-in, according to one or more embodiments of the present disclosure.

FIGS. 8A-O are pictorials illustrating examples of a user home page of the disclosed skill-rating system, which enables or otherwise facilitates a user's use of the innovative skill-rating functions of the disclosed system, according to one or more embodiments of the present disclosure.

FIGS. 9A-B are pictorials illustrating exemplary UIs which the disclosed skill-rating system may provide to let the user add a skill, according to one or more embodiments of the present disclosure.

FIGS. 10A-H are pictorials illustrating exemplary UIs that the disclosed skill-rating system may provide to allow a user to add one or more followers or raters, according to one or more embodiments of the present disclosure.

FIGS. 11A-F are pictorials illustrating exemplary UIs that the disclosed skill-rating system may provide to enable a user to create and send out a rating request and perform self-rating, and enable invited raters to answer an incoming rating request, according to one or more embodiments of the present disclosure.

FIGS. 12A-L are pictorials illustrating exemplary UIs that the disclosed skill-rating system may provide to implement group-based (team-based) skill-rating functions, according to one or more embodiments of the present disclosure.

FIGS. 13A-I are pictorials and a flowchart, which collectively illustrate exemplary UIs as well as processing blocks that the disclosed skill-rating system may use to implement a group-based rating request used to receive rating data on group skills for individual members of a group, according to one or more embodiments of the present disclosure.

FIGS. 14A-C are pictorials illustrating exemplary UIs which the disclosed skill-rating system may provide to enable a user to view the user's skill data and used-for-skillrating activity data, according to one or more embodiments of the present disclosure.

FIGS. 15A-B are pictorials illustrating exemplary UIs which the disclosed skill-rating system may provide to enable a user to view data about a user's pending rating and rating on other users, according to one or more embodiments of the present disclosure.

FIGS. 16A-K are pictorials illustrating exemplary UIs which the disclosed skill-rating system may provide to enable a user to view the user's 360-degree rating data indicating the user's progress on target skills over time, according to one or more embodiments of the present disclosure.

FIGS. 17A-C are pictorials illustrating exemplary UIs which the disclosed skill-rating system provides to enable a user to view follower and rater data as well as the user's profile data, according to one or more embodiments of the present disclosure.

FIGS. 18A-G are pictorials illustrating exemplary UIs which the disclosed skill-rating system provides to enable a user to create one or more public rating requests, and receive and view ratings and feedbacks received from the public, according to one or more embodiments of the present disclosure.

### DETAILED DESCRIPTION

In the following detailed description of exemplary embodiments of the disclosure, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

The terminology used herein is for the purpose of describing particular embodiments only and is not intended to be limiting of the disclosure. As used herein, the singular forms “a”, “an” and “the” are intended to include the plural forms as well, “or” includes “and/or,” and reference to a numerical value includes at least that value, unless the context clearly indicates otherwise. Moreover, the use of the terms first, second, etc. do not denote any order or importance, but rather the terms first, second, etc. are used to distinguish one element from another.

Functional steps illustrated herein, unless otherwise specified as, or logically required to be, performed in accordance with a specific sequence, are presumed to be performable in any order without regard to a specific sequence.

Within the descriptions of the different views of the figures, the use of the same reference numerals and/or symbols in different drawings indicates identical, similar, or close related items, and similar or closely related elements can be provided similar names, reference numerals, and reference alpha-numerals throughout the figures. If a reference numeral is once used to refer to a plurality of like elements, unless required otherwise by context, the reference numeral may refer to any, a subset of, or all of, the like elements in the figures bearing that reference numeral. A reference alpha-numeral (e.g., “821A”) may refer to one implementation or one portion of one element or a plurality of like elements bearing the same base reference numeral (e.g., “821”). The specific identifiers/names, reference numerals and reference alpha-numerals assigned to the elements are provided solely to aid in the description and are not meant to imply any limitations (structural or functional or otherwise) on the described embodiments.

In the description, relative terms such as “left,” “right,” “vertical,” “horizontal,” “upper,” “lower,” “top” and “bottom” as well as any derivatives thereof should be construed to refer to the logical orientation as then described or as shown in the drawing figure under discussion. These relative terms are for convenience of description and are not intended to convey any limitation with regard to a particular orientation.

In the present disclosure, the terms “module”, “sub-module”, “application”, “application module”, “software”, “software program”, “software module”, “programmatic module”, “code”, “application code”, “programmatic code”, “object”, “programmatic object”, “script”, “routine”, “service routine”, “function”, “service”, “engine”, “processor”, “component”, and so on, when context allows, may be used interchangeably to refer to one or more sets of computer instructions adapted to perform, when executed by a processor (such as a microprocessor or a microcontroller), one or more specific functions (e.g. a microprocessor or a microcontroller).

As used herein, the term “skill” must be construed broadly to include any “skill”, “aspect”, “character”, “feature”, “trait”, or “characteristics”, and so on, of an entity (such as a human, performance, or event), which can be rated or assessed by a human based on any demonstration or exhibition thereof by the entity that can be, for example, observed by a human or measured by one or more devices.

As used herein, the term “activity”, when used as part of or otherwise with a rating request, refers to a reference context, formed by one or more events, tasks, projects, trips, activities, meeting, conversations, performances, objectives, goals, and etc., or any combination thereof, through or during which one or more skills of a user were or have been demonstrated. Thus, the term “activity”, when used as part of or otherwise with a rating request, must be, e.g., distinguished from an “activity” reported in a newsfeed or status feed. To distinguish an “activity” used as part of or otherwise with a rating request from any other “activity” (such as an “activity” reported in a newsfeed), the former may also be referred to as “used-for-rating activity”, “used-for-skill-rating activity”, “used-for-skillrating activity”, or something similar.

As used herein, the term “group”, when used in connection with the disclosed skill-rating system, refers to an entity formed by a number of users (members) for skill-rating related purposes. Thus, the term “group” may be used interchangeably with any other term—such as “team”, “organization”, “squad”, “cohort”, and so on—to refer to an entity formed by a number of users (members) for skill-rating related purposes, so long as the latter may also refer to an entity by a number of users when used in connection with the disclosed skill-rating system.

With reference now to the figures, and beginning with FIGS. 1A-C, there are depicted block diagrams illustrating a social network based skill rating and performance feedback system (hereinafter simply referred to as “the disclosed skill rating system”) in accordance with one or more embodiments of the present disclosure.

Referring to FIG. 1A, the disclosed skill rating system 100 comprises client devices 101 and a backend system 102, which are communicatively coupled to each other via one or more communication networks 103, such as Internet, one or more cellular networks and one or more local area networks. Client devices 101, as shown in FIG. 1, can be any computing devices having networking capabilities, such as PDAs, smartphones, PCs, notebook computers and tablets. In particular, a client device 101 is equipped with client applications, which may include a web browser, which, as well known, allows the user to view information and data, input information and data, and submit information and data to backend system 102. Additionally or alternately, the client applications of a client device 101 may include one or more custom standalone applications, often referred to as “apps” in the mobile device context, which, similar to the web browser when working in concert with backend system 102 via network communications, allows user to view information and data, input information and data, and submit information and data to backend system 102. As used herein, a client application may refer to a web browser, one or more custom “apps”, and any combination thereof.

Backend system 102 comprises server 104. As used herein, the term “server” refers to any of various types of computing devices, such as computer clusters, server pools, general-purpose personal computers, workstations, or laptops. Server 104 comprises, inter alia, one or more processors 105 (such as one or more microprocessors), one or more system memories 107, one or more network interface devices 106 (not shown), and etc. In one embodiment, one or more system memories 107 include operating system 108 and application modules 109.

Backend system 102 further comprises one or more data stores 111 (hereinafter referred to as “DS 111”) communicatively coupled to the one or more processors 105 of server 104. DS 111 may exist or be implemented in one or more of various forms, such as one or more relational or objective databases, one or more local or distributed file systems, one or more removable storages, one or more system caches, one or more system memories, or any combination thereof. In embodiment, DS 111 resides in server 104. In another embodiment, DS 111 resides external to server 104.

Application modules 109 may be implemented in various forms, such as executable programs, callable functions and routines, scripts that can be executed via running of one or more interpreter programs, services that may be invoked by standard or proprietary protocols, programmatic objects containing both data and functional modules, and etc. Application modules 109 may include a web server module 110, which receives web requests from a client device (via a client application) and delivers a corresponding web response to the client device (for the client application to display to a user).

Application modules 109 may additionally or alternately include skill-rater module 112, which is an application that implements the backend business logic of the presently disclosed skill-rating and performance feedback system. Web server module 110, upon receiving an online request directed to the disclosed skill-rating system, may invoke skill-rater module 112, provide skill-rater module 112 with data the comes with the online request, and deliver one or more processing results produced by skill-rater module 112 after processing the online request. The one or more processing results may include a web page (e.g., in the form of HTML) which can be rendered by a web browser, or one or more standard or proprietary packets, which, upon received and processed by a client application, allows the client application to display the result data included therein.

Referring to FIG. 1B, skill-rater module 112, by way of example and not limitation, includes three components, namely, processing engine 121, graphical user interface (GUI) display engine 123 (referred to hereinafter simply as “display engine 123”) and data engine 122. Processing engine 121 is programmed or configured to process incoming user requests related to skill-rating and/or user data submissions related to skill-rating.

Data engine 122, which is usually called by processing engine 121, is programmed or configured to store skill-rating related data (which, e.g., is submitted by a user) and/or retrieve skill-rating related data (which, e.g., is requested by a user). In one implementation, data engine 122 is programmed or configured to store skill-rating related data in DS 111 and/or retrieve skill-rating related data from DS 111.

Display engine 123, which is usually called by processing engine 121 after results of a user request are generated or retrieved, is programmed or configured to receive output contents and generate instructions or directives (which may incorporate output contents) to render an output representation. In one implementation, display engine 123 generates a text string organized in accordance with a pre-defined markup format having presentation semantics, such as HTML, such that when a client application of a client device 101, such as a web browser or a custom application, receives the text string, the client application can render the contents embedded therein in accordance with the presentation semantics provided therein. One example of such a text string is an HTML page. Although in FIG. 1B, GUI display engine 123 is shown as included in skill-rater module 112 of application modules 109 residing in backend system 102. Display engine 123 may, in another implementation, reside in a client application of a client device 101 to perform the same or similar functionalities described above, namely, receiving output contents and generating instructions to render an output representation.

Turning to a client device 101, referring to FIG. 1C, which is a block diagram illustrating an exemplary client device 101, a client device 101 may comprise, inter alia, an input module 151, one or more processors 152, communication and interface modules 153, a system memory 154 (which may include an operating system 155 and client applications 156), a display module 157, and a storage module 158.

Examples of a processor 152 include a microprocessor and a microcontroller. The input module 151 receives input from a user and provides the received input to processors 152 for further processing by software programs running in processor(s) 152. The input module 151 may include a keyboard, an input pointing means (such as a mouse, a touchpad, a touch screen, or any combination thereof), input keys, or any combination thereof. Communication and interface modules 153 may provide wired and/or wireless networking capabilities and capabilities of interfacing with other external devices. Communication and interface modules 153 may include one or more communication devices (such as network interface device (NID), an RF unit, and antenna, or any combination thereof) and/or one or more interfacing devices (such as one or more USB connectors), as well as software or firmware modules driving or supporting aforementioned communication and/or interfacing devices. Display module 157 may include one or more display devices, such as an LCD display screen, that is used to display user input data or output data provided by an application running in the shown client device. Display module 157 may include a touch screen which also allows user to input data. In that case, Display module 157 may also serve as an input device (particularly an input pointing means) included in input module 151. Storage module 158 may include various internal and external storage media, such as RAM, ROM, hard disk, smart card, flash memory, and any external storage accessible via, e.g., the communication module or an interface module (not shown) of the client device, such as a USB interface.

One or more client applications 156 may be loaded into system memory 154 during an operation of a client device 101. Non-browser client applications are commonly referred to as “apps” when client device 101 is a smart mobile device such as a smart phone or a tablet PC. A non-browser custom client application 156 may exist in various forms. For example, a non-browser custom client application 156 may be a standalone application running in a smart phone, a tablet, PC or notebook computer. A non-browser custom client application 156 may also be a software module running inside a specific application context, such as a so-called “Facebook app” running inside a Facebook context (a social networking context), or either a Java applet or an ActiveX control running inside a web browser (which is also a client application 156).

In one embodiment, client applications 156 may include a web browser 160, which renders HTML pages received from backend system 102. In one embodiment, client applications may additionally or alternatively include a Skillrater client application 161, which is a non-browser custom application 156 (or, in other words, an “app”) implemented and provided as an integral part of the disclosed skillrater system. Custom client application 161 may include, among other functions and modules, a client-side GUI function 162.

GUI function 162 is the client-side alternative or additional implementation of UIs otherwise provided by GUI engine 123 of backend system 102 (working in concert with the client-side web browser 161). Thus, GUI function 162 may be programmed and configured to render UIs to enable a user to perform skill-rating functions, such as signing up (registering) with backend system 102, logging into backend system 102, inviting followers and/or raters, creating a rating request, rating on an incoming rate request, creating a group (team) rating request, answering a group (team) rating request, and so on. Thus, GUI function 325 may receive data from backend system 102 before rendering one or more corresponding UIs displaying the received skill-rating related data of a user, such as skill data of the user, pending rating data of the user, 360-degree feedback data of the user, member data of a group of the user, group (team) rating data of a group of the user, rater data of the user, profile data of the user, and public rating data of an event of the user (if the user is subscribed to the needed membership), and so on.

Turning back to backend system 102, FIG. 2 shows two block diagrams illustrating an exemplary implementation of DS 111, according to one or more embodiments of the present disclosure. Referring to FIG. 2, DS 111 may comprise component data stores including, by way of example and not limitation, user profile DS 201, user skill DS 202, user relationship DS 203, activity DS 204, rating request DS 205, rating DS 206, skill DS 207, notification DS 208, newsfeed DS 209 and group DS 210. The component data stores may be linked to one another (via, e.g., one or more linking fields linking two component data stores).

User profile DS 201 may be configured to store registration and profile data of users joining the disclosed skill-rating system. By way of example and not limitation, the stored registration and profile data of a user may include the user's identification number (hereinafter simply referred to as “user ID”), the user′ name, the user's e-mail, the user's login username, the user's login password, the date and time at which the user registered with the disclosed skill-rating system, the user's employment information, the user's self-description, the user's qualification information (such as the educational degrees that the user has received, the user's places of study, the user's career concentrations), and etc.

User skill DS 202 may be configured to store skill data of users. By way of example and not limitation, the stored skill data of a user (identified by a user ID) may include one or more skills (each identified by a skill ID) associated with the user, the date on which a skill was added to be associated with the user, the average rating of a skill associated with the user and the category in which a skill associated with the user is designated.

User relationship DS 203 may be configured to store relationship data between users. By way of example and not limitation, stored relationship data between users may include one or more relationships between two users A and B. By way of example and not limitation, types of relationships may include whether user A is a follower of user B or vice versa, whether user A has rated user B or vice versa, whether user A is a superior, peer, subordinate, or external customer of user B, or vice versa. Stored relationship data may further include the date on which a relationship is registered, created or established.

Activity DS 204 may be configured to store activity data for skill-rating purposes. In one aspect of the disclosed skill-rating system, a rating on a skill (which can be either an individual skill or a group-skill) of a user is associated with an “activity” defined by the user. Thus, a rating of a skill at a certain point in time is not given in a vacuum, but instead is linked to a concrete “activity”. By way of example and not limitation, stored activity data may include an ID identifying an activity, the name of the activity and the description of the activity. Stored activity data further include an expiration date, a vanity URL and information about an episode, if an activity is or is associated with a public or broadcast event.

As used herein, the term “activity”, when used in a context linked to skill-rating, may refer to any of an event, a task, a mission, an assignment, an activity, or any combination thereof, in which a participant's level of a skill may be demonstrated. A user may improve a skill over time as the user is involved in more activities of same, similar or different natures. Thus, by associating a rating of a skill with a concrete event, the user's improvement of the skill may be seen over time through progressive ratings of the skill associated with a series of activities as given by fellow followers of the user involved in the same.

Rating request DS 205 may be configured to store data relating to rating requests. In one aspect of a disclosed skill-rating system, a user may send a rating request to each of potential raters of the user's selections, requesting that one or more selected individual skills or group-skills associated with an activity be rated. In other words, a user may send multiple rating requests associated with an activity to multiple users. If an invited potential rater is a user who has already signed up with a disclosed system, a rating request will be listed as a notification posted on the selected user's home page of the disclosed system. If an invited potential rater has not signed up with the disclosed system, a rating request will be send to a messaging address of the selected potential rater (such as an e-mail address) provided by the user sending the rating request. Thus, by way of example and not limitation, stored rating request data may include an ID identifying a rating request, the ID of the user initiating the rating request, the ID of a potential rater who has signed up with the disclosed system, an e-mail address of a potential rater has not signed up with the disclosed system, the ID identifying the activity associated with the rating request, information about one or more individual skills and/or group-skills selected to be rated, and a flag indicating whether the rating request is ignored by a selected potential rater.

Rating DS 206 may be configured to store data relating to ratings of skills of users associated with activities resulting from rating requests initiated by users. As noted in connection with rating request DS 205, a user may send a rating request to each of potential raters of the user's selections, requesting that one or more selected individual skills or group-skills associated with an activity be rated. Upon receiving a rating request, an invited potential rater (invitee) may choose to accept the rating request by rating one or more skills (individual skills or group-skills) associated with the activity included in the rating request.

In particular, a rating given by an invitee (rater) may include two parts. The first part may be feedback text provided by the rater. In one embodiment, the feedback may include the rater's appreciation for the work that the inviting user has done for the activity. The second part may be a rating on each of one or more skills (individual skills or group-skills) included in the rating request. A rating may be stored in the form a numerical value between two boundary values forming a scale. Also, the rating data may include information about the rater's relationship to the inviting user. Assuming that the inviting user invites multiple invitees to rate his skills associated with the activity, with the invitees having different relationships to the inviting user, the inviting user, upon receiving the multitude of feedbacks and ratings from the invitees, can readily see how raters having different relationships evaluate his contributions and skills associated with the activity.

Hence, by way of example and not limitation, rating data stored in rating DS 206 may include the user ID identifying the user sending out the rating request, the user ID identifying the rater (invitee) giving the rating, the ID identifying the rating request, the ID identifying the activity included in the rating request, the rater's appreciation, the rating value given to a particular skill (which may be an individual skill or a group skill) included in the rating request, and the date on which the rating is made.

Skill DS 207 may be configured to store default and custom skill data. By way of example and not limitation, the stored skill data may include an ID identifying a skill, the title of the skill, the ID of a user who created the skill, the ID identifying a skill category to which the skill belongs. The stored skill data may further include skill category data. The stored skill category data may include an ID identifying a skill category, the name of the skill category, the description of the skill category and an ID identifying a parent category (if the skilled categories are structured in a hierarchical manner).

Notification DS 208 may be configured to store skill-rating related notification data. In one aspect of the disclosed skill-rating system, a user is informed of events that may require the user's attention or action through notifications listed on the user's home page of the disclosed skill-rating system. Examples of notifications may include notifications of incoming rating requests sent by other users, notifications of follower invitations from users who would like the user to become a follower of the inviting users and notifications that an invitee user, upon receiving a rating request sent by the user, has rated the user. Hence, by way of example and not limitation, stored notification data may include information about the actor of the notification, the target of the notification, the content of the notification, the type of the notification, one or more parameters of the notification (if there is any), and the date and time at which the notification is created.

Newsfeed DS 209 may be configured to store skill-rating related newsfeed information related to a user. In one aspect of the disclosed skill-rating system, for a user, the skill-rating system “feeds” the user a list of recent skill-rating related news slips of the user—or, in other words, text reporting skill-relating related events pertaining to the user” or other user who have a relationship with the user (such as followers of a user)—so that the user may conveniently become aware of recent skill-rating related events that the user may be interested in knowing, comment on one or more noted news slips, “like” one or more news slips, or share one or more news slips in one or more other social networks of the user (such as Facebook or LinkedIn), as the user wishes.

Examples of news slips may include: (1) a news slip indicating that an actor user (who may be the user or a follower of the user) requests rating for an activity to a target user (who may be a member of a group of which the user is also a member); (2) a news slip indicating that an actor user has joined a group; (3) a news slip indicating that two users related to the user are now following each other; and (4) a news slip indicating that one actor user has rated one target user on an activity. A listed news slip may also include additional detail information regarding the event stated therein. For example, the above-noted 4^{th} news slip example may further include detailed ratings of skills and appreciation given by the actor user.

Hence, by way of example and not limitation, for each news slip, stored newsfeed data may include information about: an actor who may initiated the event, an action (such as providing rating, joining a group) involved or featured in an event, a target user who received the event if there is one, whether a group is involved, the group, one or more IDs that may identify the event (such as an ID identifying a rating request or an ID identifying or an ID identifying a rating), a description of the event and a title of the event.

Group DS 210 may be configured to store group data associated with skill-rating. The disclosed skill-rating system, under certain one or more conditions (e.g. if a user signs onto a particular type of membership), allows a user to create one or more groups for skill-rating purposes. In particular, the user who creates a group becomes the default manager of the group and thus can manage the group. A manager of the group can invite other users to become a member of the group. A manager of the group can also first identify, then add and define, one or more “group-skills”, each of which, for illustration and not limitation, is a “skill” which a group manager chooses to evaluate certain aspect of performances of some or all of group members. Thus, in many cases, a group-skill may be defined to reflect a priority of a group manager specifically applicable to the group in evaluating the performance of group members. With a set of group-skills defined, group members may be rated on a uniform set of “skills” Additionally, as will be described below, group-skills may be used to facilitate public ratings on one or more public performances, such as a live concert or a TV series broadcast on a network TV station.

As shown in FIG. 2, by way of example and not limitation, group DS 210 may comprise group profile DS 221, group-skill DS 222, group member DS 223, group bulletin DS 214, group discussion DS 225, and team rating request DS 226.

Group profile DS 221 may be configured to store profile data of different groups. Stored profile data of a group may include an ID, a name, a description, a category, member count and date of creation, thereof.

Group-skill DS 222 may be configured to store group-skill data of different groups. Stored data of a group-skill may include the group ID of a group for which the group-skill is defined, a description of the group-skill (such as the group ID), the user who creates the group-skill, the skill category of the group-skill, and the date on which the group-skill is added to the group.

Group member DS 223 may be configured to store member information of different groups. Stored member information may include the group ID of a group to which a member belongs, the member information (such as the user ID of the member), the permission level of the member (e.g., whether the member is a manager of the group), and the date on which the member joined to the group.

Group bulletin DS 224 may be configured to store bulletin data of different groups. Stored group bulletin data may include the group ID of a group for which a bulletin entry is, the title of the bulletin entry, the text of the bulletin entry, information about a member who creates the bulletin entry, and the date on which the bulletin entry was posted.

Group discussion DS 225 may be configured to store discussion data of different groups. Stored group discussion data may include the group ID of a group for which a discussion is, information about a discussion which is the parent of the discussion (given that group discussions may be structured in a hierarchical manner), the title of the discussion, the text of the discussion, information about a member who creates the discussion, and the date on which the discussion was posted.

Team rating request DS 226 may be configured to store data relating to team rating request, as will be discussed below in connection with FIGS. 13A-K.

FIGS. 3A and 3B are block diagrams illustrating processing engine 121 of skill-rater module 112. By way of example and not limitation, component modules of processing engine 121 may comprise user request mapper 301, UI request handler 302, normal sign-up/login processor 303, social network sign-up/login processor 304, skill-rating data submission processors 305, skill-rating data request processors 306, and char processor 307.

User request mapper 301 is a component module that maps an incoming user request to a component module of processing engines programmed or configured to handle the incoming user request and invokes the mapped component module. For example, if an incoming user request is a user normal login request, user request mapper 301 maps the request to normal sign-up/login processor 303 and calls the mapped normal sign-up/login processor 302.

UI request handler 302 is programmed and configured to handle a user's request for providing one or more UIs to enable the user to submit a specific set of data or information. Normal sign-up/login processor 303 is programmed or configured to process a normal user sign-up or login request. Social network sign-up/login processor 303 is programmed or configured to process a user sign-up or login request based on the user's successful authentication into a social network provider. Chart processor 307 is programmed or configured to process a user request for displaying, e.g., a skill-chart or a spider chart (showing 360-degree ratings from raters of different relationships to a user).

Skill-rating data submission processors 305 are programmed or configured to process data submissions made by a user. In many cases, each of skill-rating data submission processors 305, upon receiving submitted data, may call one or more corresponding component modules of data engine 122, which may form one or more data models (which may also be referred to as “structures” or “objects”) using the submitted data, and use the formed data models to store submitted data and/or data derived from submitted data into one or more component data stores of DS 111 for later retrieval. Examples of how a skill-rating data submission processor forms one or more data models using submitted data and uses the formed data models to store submitted data and/or data derived from submitted data into one or more component data stores of DS 111 will be further provided below. Following a successful storing of the submitted data, each of skill-rating data submission processors 305 may call one or more corresponding component modules of display engine 123, which may then generate an output representation indicating to the submitting user that the submitted data has been stored successfully.

As illustrated in FIG. 3B, skill-rating data submission processors 305 may comprise rating request submission processor 321, rating submission processor 322, skill-related submission processor 323, follower-rated submission processor 324 and group-related submission processor 325. Rating request submission processor 321 processes user submissions of rating requests. Rating submission processor 322 processes user submissions of rating data. The submissions may result from a user performing skill-rating on an inviting user in response to a rating request sent by the inviting user or a user performing skill-rating on a public or broadcast performance via a vanity URL. Skill-related submission processor 323 process user submissions of skill-related data. The submissions may result from a user's submission of a request to add one or more skills to the user's skill list or to remove one or more skills from the user's skill list. Follower-related submission processor 324 processes user submissions of follower-related data. The submissions may result from a user's submission of an invitation to invite another user to be a follower of the user or to remove an existing follower user from the user's list of followers, or a user's submission of acceptance of becoming a follower of an inviting user (in response to a follower invitation sent by the inviting user). Group related submission processor 325 processes user submissions of group-related data. The submissions may result from a group manager's submission of a request to add a group-skill or to remove an existing group member, or a group manager's submission of a member invitation to invite a user to join the group as a member. The submissions may also result from a group user's request to create a discussion or to add a bulletin entry, or an invited user's submission of acceptance of becoming a member of a group (in response to a member invitation sent by a manager of the group).

Returning to FIG. 3A, skill-rating data request processors 306 are programmed or configured to process user requests for skill-rating related data. In many cases, skill-rating data request processors 306, upon receiving a user request for skill-rating related data, may call one or more corresponding component modules of data engine 122, which may form one or more queries based on the user request, and use the formed query to retrieve requested data from DS 111. Following a successful retrieving of the submitted data, each of skill-rating data submission processors 305 may call one or more corresponding component modules of display engine 123 and supplies the called component modules of display engine 123 with some or all of the retrieved data. The called component modules of display engine 123 may then generate an output representation displaying some or all of the retrieved data for the user to view or edit.

As illustrated in FIG. 3B, skill-rating data request processors 306 may comprise user profile data request processor 341, follower data request processor 342, skill data request processor 343, rating-request data request processor 344, rating data request processor 345, group data request processor 346, and activity data request processor 347. User profile data request processor 341 processes requests for profile data of a user. Follower data request processor 342 processes requests for data relating to followers of a user. Skill data request processor 343 processes requests for data relating to one or more skills of a user. Rating-request data request processor 344 processes requests for data relating to either incoming rating requests (on skills) from other users or outgoing rating requests (on skills) which a user has sent to other users. Rating data request processor 345 processes requests for data relating to either ratings (on skills) which other users have given to a user or ratings (on skills) which the user has given to other users. Group data request processor 346 processes requests for data relating to a group of which a user is a member. For example, Group data request processor 346 processes requests for a list of members of a group, a list of group-skills of a group, recent bulletin entries of a group, or recent discussions of a group. Activity data request processor 347 processes requests for data relating to activities of a user based on which feedback and ratings of skills are provided.

FIGS. 4A-C are block diagrams illustrating data engine 122 of skill-rater module 112. As shown in FIG. 4A, data engine 122 may comprise data model components 400 and data list components 440.

Data model components 400 are component modules configured and programmed to store or update received input skill-rating related data into DS 111 or remove data from DS 111 data entries identified by input skill-rating related data.

As used herein, the terms “update” and “updating”, when used in the context of a database, refers to one or more database operations inclusive of any of a storing operation, a removing operation, or a data-record-creation operation, or any combination thereof, so long as the one or more database operations cause one or more changes in data stored in the underlying database(s) on which the one or more database operations are performed.

Referring to FIG. 4B, data model components 400, by way of example and not limitation, may comprise user profile model component 401, user skill model component 402, user relationship model component 403, activity model component 404, rating request model component 405, rating model component 406, skill model component 407, notification model component 408, newsfeed model component 409, and group related model components 410. Group related model components 410 may further comprise group profile model component 421, group member model component 422, group-skill model component 423, group bulletin model component 424, group discussion model component 425, and team rating request model component 426.

In one embodiment, as far as data-storing is concerned, user profile model component 401, user skill model component 402, user relationship model component 403, activity model component 404, rating request model component 405, rating model component 406, skill model component 407, notification model component 408, newsfeed model component 409, and group related model components 410, correspond to user profile DS 201, user skill DS 202, user relationship DS 203, activity DS 204, rating request DS 205, rating DS 206, skill DS 207, notification DS 208, newsfeed DS 209, and group DS 210, respectively. Additionally, group profile model component 421, group member model component 422, group-skill model component 423, group bulletin model component 424, group discussion model component 425, team rating request model component 426, correspond to group profile DS 221, group-skill DS 222, group member DS 223, group bulletin DS 214, group discussion DS 225, team rating request DS 226, respectively.

In one implementation, each of the data model components may be programmed or configured to store or update corresponding input data in its corresponding component data store, or remove corresponding data records using input data as criteria, based on one or more data models. One example of a data model is a data structure having a set of data members. A data model may also include one or more functions tailored to store data members included therein into a data sore. The one or more data models may be tailored according to the underlying structure of DS 111. For example, if DS 111 is an object-oriented database, the one or more data models may be constructed to include one or more objects corresponding to object definitions required for the corresponding one or more component data stores of DS 111. If DS 111 is a relational database, the one or more data models may be constructed to map data members thereof to columns of tables included in the corresponding one or more component data stores of DS 111. Thus, as an example, user profile model component 401 may include one or more data models tailored to store uploaded or imported user profile data (which may include personal information, employment information, and education information of a user) into its corresponding component date store, namely, user profile DS 201. Similarly, each of other data model components may include one or more data models tailored to store uploaded or imported corresponding data into its corresponding component data store.

Data list components 440 are component modules each configured and programmed to retrieve a specific set of data from one or more component data stores of DS 111, and optionally further filter and organize the retrieved data in a custom manner. Referring to FIG. 4C, data list components 440, by way of example and not limitation, may comprise user profile list component 441, user skill list component 442, rater and follower list component 443, activity list component 444, rating request list component 445, rating list component 446, skill list component 447, and notification list component 448, newsfeed list component 449, and group related list components 450. Group related list components 450 may further comprise group profile list component 461, group member list component 462, group-skill list component 463, group bulletin list component 464, group discussion list component 465 and user group list component 466.

User profile list component 441 may retrieve a list of profile information of a user, such as personal information of the user, employment information of the user and education information of the user. User skill list component 442 may retrieve a list of information about skills of a user. Rater and follower list component 443 may retrieve a list of information about raters and followers of a user. Activity list component 444 may retrieve a list of information about activities of a user. Rating request list component 445 may retrieve a list of information about incoming rating request of user or outgoing rating request of a user. Rating list component 446 may retrieve a list of information about ratings of skills on a user or ratings of skills that a user provided to other users. Skill list component 447 may retrieve a list of information about default and custom skills. Notification list component 448 may retrieve a list of information about notifications of a user. Newsfeed list component may retrieve a list of skill-rating related news involving either raters or followers of a user.

Similarly, group profile list component 461 may retrieve a list of profile information of a group, which may include the name of the group and the description of the group. Group member list component 462 may retrieve a list of information about members of a group. Group-skill list component 463 may retrieve a list of information about group-skills of a group. Group bulletin list component 464 may retrieve a list of information about bulletin entries of a group. Group discussion list component 465 may retrieve a list of information about a list of information about discussions of a group. User group list component 466 may retrieve a list of information about one or more groups of which a user is a member.

Each of data list components 440 may use one or more parameters, such as a user ID identifying a user, and includes programmatic code adapted to retrieve a specific set of data from one or more component data stores of DS 111 based on one or more values respectively set for the one or more parameters. In one implementation, in retrieving a specific set of data, the programmatic code is adapted to query against one or more component data stores of DS 111 using the respective values set for the one or more parameters.

In one implementation, each of the data list components may retrieve some or all of target list data from a corresponding component data store of DS 111. As far as data-retrieval is concerned, user profile list component 441, user skill list component 442, rater and follower list component 443, activity list component 444, rating request list component 445, rating list component 446, skill list component 447, and notification list component 448, newsfeed list component 449, and group related list components 450, correspond to user profile DS 201, user skill DS 202, user relationship DS 203, activity DS 204, rating request DS 205, rating DS 206, skill DS 207, notification DS 208, newsfeed DS 209, and group DS 210, respectively. Additionally, group profile list component 461, group member list component 462, group-skill list component 463, group bulletin list component 464, group discussion list component 465, user group list component 466, and team rating request list component 467, correspond to group profile DS 221, group-skill DS 222, group member DS 223, group bulletin DS 214, group discussion DS 225, group member DS 223, and team rating request DS 226, respectively.

Thus, as an example, rater and follower list component 443 may retrieve a list of information about raters and followers of a user A from its corresponding user relationship DS 203. Rater and follower list component 443 may use two parameters—namely, a user ID parameter identifying the user whom the retrieved rater and follower list is with respect to, and a relationship type parameter identifying one or more relationship types between users included in the retrieved list and the user. In retrieving a list of information about raters and followers of a user A, rater and follower list component 443 queries against user relationship DS 203 by setting the value of the first user ID parameter to a user ID identifying user A and setting the value of the second relationship type parameter to either the “follower” type or the “rater” type.

As another example, activity list component 444 may retrieve a list of skill-rating activities of a user A during recent three months from its corresponding activity DS 204 by setting three values respectively set for three parameters—namely, (1) setting the user ID of user A as the value of the user ID parameter identifying the user whom the target activity list is with respect to, (2) setting today's date as the value of the date parameter specifying the end date of the target period (during which the target list of “activities” are created for skill-rating purposes), and (3) setting the date of three months before today's date as the value of the date parameter specifying the start date of the target period.

As yet another example, two different list components may correspond to a same component data store of DS 111 but use different sets of parameters. For example, group member list component 462 and user group list component 466 both correspond to the same group member DS 223. Group member list component 462 retrieves from group member DS 223 a list of information about members of a group by setting one parameter value—namely, setting the ID identifying the group (of which the members are to be retrieved) as the value of the group ID parameter. On the other hand, user group list component 466 retrieves from group member DS 223 a list of information about groups with which user A is associated, by setting a different parameter value—namely, setting the user ID identifying user A as the value of the member ID parameter.

As yet another example, in retrieving a specific set of data, a list component may take additional steps against additional component data stores to retrieve additional information after taking a preliminary step of retrieving a list of core information from a corresponding component data store. For example, rating request list component 445 may retrieve from its corresponding rating request DS 205 a list of information about incoming rating requests or outgoing rating requests of a user. The retrieved list of information may include activity ID for each rating request. To retrieve detailed information about the activity associated with each retrieved rating request, rating request list component 445 may then take an additional step of querying against activity DS 204 by setting the value of the activity ID parameter to be collection (such as a set or an array) inclusive of all activity IDs retrieved in the earlier step of retrieving the list of information about rating requests.

As a skilled artisan appreciates, list components illustrated in FIG. 4C are merely exemplary. Different or additional list components may be implemented and provided to meet corresponding needs of retrieving different or additional specific sets of data that may arise. Also, the implementations described above in connection with exemplary list components are merely exemplary. Other implementations may be used to achieve same or similar data retrieval objectives without departing from the scope and spirit of the present disclosure.

FIGS. 5A-C are block diagrams illustrating display engine 123 of skill-rater module 112. Referring to FIG. 5A, display engine 123, by way of example and not limitation, may comprise one or more main viewer components 501, and section viewer components such as request UI components 502 and dynamic viewer components 503.

Each of main viewer components 501 is programmed, structured or configured to provide a main display framework for representing various skill-rating related content of a user. A main display framework may include a layout for displaying one or a plurality of contents. A main display framework can be as simple as only including a display frame surrounding empty content. A main viewer component 501 may be so programmed, structured or configured as to enable other section viewer components to be plugged into, and thus incorporated into, the main display framework provide therein.

In one exemplary implementation, a main viewer component 501 is implemented as a template incorporating a main display framework defined by the HTML markup language. The template may be implemented in one of programming languages supporting generation of dynamic HTML, such as PHP, Python, Java, C, C++ and so on. The main display framework may incorporate sections where static or dynamic section viewer components (which may be implemented in one of programming languages supporting generation of dynamic HTML), such as request UI components 502 and dynamic viewer components 503, may be plugged in to incorporate the representation of corresponding content data of the user there-within.

A main display framework may also incorporate software code of one or more client-side scripting languages, such as Javascript code, to achieve functionalities such as enabling or enhancing interaction between the user and the display of the content (defined by the main display framework), or enabling the client application hosting the display (such as a web browser) to communicate asynchronously with backend system 102 and altering the displayed document content. A main display framework may further incorporate styling components, such as CSS, to define or customize look and feel thereof as well as look and feel of the content data represented therein.

Request UI components 502 are UI component modules each programmed, structured or configured to provide one or more user interfaces to enable a user to submit a skill-rating related request to backend system 102. Skill-rating related requests may include requests for submitting skill-rating related data of the user to backend system 102 (such as a request for creating a rating request or a request for adding a skill) and requests for performing a specific skill-rating related task on the user, such as a request for authenticating the user or a request for sending follower invitations to guests of the user.

Dynamic viewer components 503 are UI component modules each programmed or configured to display skill-rating related content data in a manner that allows a user to view a subset or all of the received content data within a viewing area. In particular, a dynamic viewer component may be a “list viewer” module programmed or configured to present a view of a list of dynamically received data within a viewing area. A “list viewer” may provide different views for the same received list data based on one or more parameters defining a target view. As one example, a “list viewer” may provide a “partial view” if an input parameter requires the target view to be “partial view”. Thus, in this example, the “list view” may be configured to display only a selected or filtered subset of the received list data within the viewing area while provide one or more clickable UI elements clicking of which enables displaying of the whole set of the received list data. A dynamic viewer component may also include one or more UI elements that enable the user to edit or act on (e.g., remove, comment on or perform an action on) some or all of the content data, such that the corresponding underlying content data stored in backend system 102 (stored via, e.g., DS 111) are updated accordingly.

In one implementation, a request UI component 502 may be a static module ad adapted to provide one or more user interfaces independent of or external to the main display framework (provided by a main viewer component 501), such as a user interface provided in a pop-up window. Alternately or additionally, a request UI component 502 or a dynamic viewer component 503 may be adapted to provide a plug-in UI component module that can be integrated into the main display framework. In one implementation, a request UI component 502 may be a static module implemented as an HTML page or an HTML section. In another implementation, a request UI component 502 or a dynamic viewer component 503 may be implemented in one of programming languages (such as PHP, Python and Java), resulting in dynamically generating a representation of corresponding content data by dynamically generating, e.g., HMTL code or other content-embedding code or instructions that can be interpreted or used for graphics rendering and display.

Referring to FIG. 5B, request UI components 502, by way of example and not limitation, may comprise sign-up/login UI component 521, rating request UI component 522, follower invitation UI component 523, user skill creation UI component 524, rating provision UI component 525, rater selector UI component 526 and group-related request UI components 527. Group-related request UI components 527 may comprise group creation UI component 541, group-skill creation UI component 542, group member invitation UI component 543, and group setting UI component 544.

Sign-up/login UI component 521 may be adapted to provide one or more user interfaces for submitting a sign up or login request. Rating request UI component 522 may be adapted to provide one or more user interfaces for submitting a request for rating one or more skills of a user. Follower invitation UI component 523 may be adapted to provide one or more user interfaces for a user to invite one or more other users to be a follower of the user. User skill creation UI component 524 may be adapted to provide one or more user interfaces for a user to create a custom skill or add a standard skill as part of the skill list of a user. Rating provision UI component 525 may be adapted to provide one or more user interfaces for a user to rate and/or provide feedback (such as appreciation) on one or more skills of another user. Rater selector UI component 526 may be adapted to provide one or more user interfaces for selecting one or more potential raters (usually from a social network of a user) to whom invitations to rate on one or more skills of the user are to be sent.

Group creation UI component 541 may be adapted to provide one or more user interfaces for creating a group for skill-rating purposes. Group-skill creation UI component 542 may be adapted to provide one or more user interfaces for a manager user of a group to create a group-skill as part of the group-skill list of the group. Group member invitation UI component 543 may be adapted to provide one or more user interfaces for a manager user of a group to invite one or more users to become a member of the group. Group setting UI component 544 may be adapted to provide one or more user interfaces for a manager user of a group to view or edit one or more skill-rating related settings of the group.

Dynamic viewer components 503, by way of example and not limitation, may comprise follower list viewer component 561, activity list viewer component 562, skill list viewer component 563, rating request list viewer component 564, rating list viewer component 565, notification list viewer component 566, newsfeed list viewer component 567, chart viewer component 568 and group-related viewer components 569. Group-related viewer components 569 comprises group profile viewer component 581, group member list viewer component 582, group-skill list viewer component 583, group bulletin list viewer component 584, group discussion list viewer component 585 and user group list viewer component 586.

Follower list viewer component 561 may be adapted to provide one or more user interfaces to display a partial or complete list of data about followers of a user for the user to view or edit the same follower data as needed. Activity list viewer component 562 may be adapted to provide one or more user interfaces to display a partial or complete list of data about skill-rating related activities of a user for the user to view or edit the same activity data as needed Skill list viewer component 563 may be adapted to provide one or more user interfaces to display a partial or complete list of data about skills of a user for the user to view or edit the same skill data as needed. Rating request list viewer component 564 may be adapted to provide one or more user interfaces to display a partial or complete list of data about either incoming rating requests sent to a user from other users or outgoing rating requests sent to other users by the user, for the user to view or act on the same rating requests as needed. Rating list viewer component 565 may be adapted to provide one or more user interfaces to display a partial or complete list of data about either ratings (including feedbacks) on skills of a user provided by other users or ratings (including feedbacks) on skills of other users provided by the user, for the user to view or edit the same rating data as needed. Notification list viewer component 566 may be adapted to provide one or more user interfaces to display a partial or complete list of data about skill-rating related notifications for the user to view or act on the same notifications as needed. Newsfeed list viewer component 567 may be adapted to provide one or more user interfaces to display a partial or complete list of data about skill-rating related newsfeed associated with a user's followers and raters for the user to view or act on (e.g., comment on) the same newsfeed data as needed. Chart viewer component 568 may be adapted to provide one or more user interfaces to display, e.g., a visual skill chart or spider chart with regard to ratings of skills of a user for the user to have a 360 degree view on the ratings of a specific set of skills or group-skills of the user associated with a specific activity from people having different business relationships to the user.

Group profile viewer component 581 may be adapted to provide one or more user interfaces to display a partial or complete list of data about a group profile for a user associated with the group to view or edit the same group file data as permitted or needed. Group member list viewer component 582 may be adapted to provide one or more user interfaces to display a partial or complete list of data about one or more members of a group for a user associated with the group to view or edit the same group member data as permitted or needed. Group-skill list viewer component 583 may be adapted to provide one or more user interfaces to display a partial or complete list of data about one or more group-skills of a group for a user associated with the group to view or edit the same group-skill data as permitted or needed. Group bulletin list viewer component 584 may be adapted to provide one or more user interfaces to display a partial or complete list of data about one or more bulletin entries of a group for a user associated with the group to view or act on the same group bulletin data as permitted or needed. Group discussion list viewer component 585 may be adapted to provide one or more user interfaces to display a partial or complete list of data about one or more discussions of a group for a user associated with the group to view or act on (e.g. comment on or follow up with) the same group discussion data as permitted or needed. User group list viewer component 586 may be adapted to provide one or more user interfaces to display a partial or complete list of data about one or more groups with which a user is associated, for the user view or edit the same user group data as permitted or needed.

FIGS. 6A-6D are flowcharts exemplifying steps used in the disclosed skill-rating system's handling of typical skill-rating related user requests, according to one or more embodiments of the present disclosure.

FIG. 6A is a flowchart exemplifying a process for handling a UI request and providing one or more UIs to allow the user to submit a specific set of data to backend system 102. As used herein, a “UI request” refers to a request for provision of an UI that a user may use to submit a set of data as well as a request for performing a designated action using the submitted set of data.

Referring to FIG. 6A, at block 601, either the client application or backend system 102 receives and processes a UI request for providing one or more UIs for specific data submission. The UI request is usually sent via the client application. Examples of such a UI request will be further provided below with reference to concrete UIs. In a first scenario, in receiving the UI request, the client application processes (handles) the UI request without forwarding the UI request to backend system 102. In a second scenario, in receiving the UI request, the client application forwards the UI request to backend system 102.

In the first scenario noted above, the client application may call one or more of its own modules programmed and configured to handle the UI request. In the second scenario noted above, backend system 102, in receiving the UI request (via, e.g., web server module 110), may forward the UI request to UI request handler 302 (through skill-rater module 112 and processing engine 121).

At block 602, display engine 123 is invoked by either the client application or backend system 102 to generate UI instructions to render a corresponding UI for the user to submit specific data. As noted in connection with display engine 123, display engine 123 may reside in either the client application or skill-rating module 112 of backend system 102. The generated UI instructions are used by the client application to display the UI. Specifically, in the first scenario noted above (namely, if the client application handles the UI request without forwarding the UI request to backend system 102), the client application may invoke its display engine 123 to locally generate rendering instructions (UI instructions) that results in the display module displaying a corresponding UI that can satisfy the UI request.

In the second scenario noted above (namely, if the client application forwards the UI request to backend system 102), UI request handler 302 invokes display engine 123. In invoking display engine 123, UI request handler 302 may first analyze the UI request so as to map the UI request to one or more section viewer components. In particular, UI request handler 302 may map the UI request to one or more request UI components 502 as one or more section viewer components that will provide the necessary section UI corresponding to the UI request. UI request handler 302 may then call applicable component modules of display engine 123, including the mapped one or more request UI components 502, to generate UI instructions (e.g. in the form of one or more HTML pages or sections or other XML-based text strings including presentation semantics) to render a corresponding UI that can satisfy the UI request, as will be further exemplified in functional blocks exemplified in FIG. 6D.

At block 603, the client application receives UI instructions generated at block 602 either from the client application's own display engine 123 or from display engine 123 of backend system 102, and displays a corresponding UI (on the display module) using the received UI instructions. The user may then use the corresponding UI to submit specific data to backend system 102.

FIG. 6B is a flowchart exemplifying steps involved in the disclosed skill-rating system's handling of a request to perform a specific action by backend system 102 on behalf of the requesting user. Such a request may involve submitting user-provided data, retrieving certain data from DS 111, or both. Hereinafter, for the ease of discussion, such a request will be simply referred to as “an action request”.

Referring to FIG. 6B, at block 611, the client application displays one or more UIs that enables a user to submit a specific action request.

At block 612, backend system 102 receives the action request (via web server module 311), and forwards the action request to user request mapper 301, (through skill-rater module 112 and processing engine 121). User request mapper 301 then maps the action request to one or more processor components of processing engine 121 that are programmed and configured handle the action request, and calls the mapped processor components. The processor components then call one or more components of data engine 122 to store and/or retrieve data as needed, and generates output data (which may include error data if an error has occurred during data storing and/or data retrieval).

At block 613, display engine 123 is invoked by the mapped processor components with the generated output data, by either the client application or backend system 102, to generate UI instructions to render an output representation. In invoking display engine 123, the mapped processor components may locate one or more section viewer components, such as one or more dynamic viewer components 503 programmed and configured to present the generated output data, which will provide the section UIs included in an output representation. The processor modules may then call applicable component modules of display engine 123, including the located one or more section viewer components, to generate UI instructions (e.g. in the form of one or more HTML pages or sections or other XML-based text strings including presentation semantics) to render an output representation, as will be further exemplified in functional blocks exemplified in FIG. 6D.

At block 614, the client application receives the generated UI instructions, and renders and displays an output representation using the received UI instructions. This block is same as or similar to block 603 of FIG. 6A.

FIG. 6C is a flowchart exemplifying more detailed steps used to implement block 612 of FIG. 6B. At block 621, user request mapper 301 maps the action request to one or more processor component modules of processing engine 123 programmed and configured to handle the action request, and calls the mapped one or more processor component modules to process the action request.

At block 622, the mapped one or more processor component modules performs custom processing on the action request as needed. Examples of custom processing will be further provided below.

At block 623, if the action request requires storing data, such as data or information which the user submitted with the action request, or derived, imported or generated during the custom processing performed at block 622, the mapped one or more processor component modules may call one or more corresponding data model components 400 to store data into DS 111.

At block 624, if the action request requires retrieval of a specific set of data, the mapped one or more processor component modules may call one or more corresponding data list components 440 to retrieve the specific set of data from DS 111.

At block 625, if the action request requires submission of data, the mapped one or more processor component modules may analyze the data submission, calls newsfeed model component 409 to create one or more newsfeed entries corresponding to the data submission and store the created newsfeed data entries into newsfeed DS 209. Thus, examples of such an action request may include an action request to create a rating request, an action request to creating a rating, an action request to accept an invitation to become a member of a group, and action request to accept an invitation to become a follower of a user.

At block 626, the mapped one or more processor component modules generates output data resulting from the handling of the action request. The output data may include the data retrieved during block 623. If the handling of the action request is successful, the output data may also include status information indicating the successful handling. If the handling of the action request involves one or more operation failures, such as data retrieval or data storage failure, the output data may further include error data indicating such failures.

FIG. 6D is a flowchart exemplifying more detailed steps used to implement block 602 of FIG. 6A or block 613 of FIG. 6B by display engine 123, with respect to generating UI instructions to render an output display (such as a UI for data submission in connection with block 602 or an output representation in connection with block 613).

At block 631, display engine 123 calls or loads a main viewer component 501 to generate UI instructions to render a main display framework. Specifically, a main viewer component 501 can be implemented as one or more programmatic routines including a set of programmatic code, a template file or string containing presentation semantics and placeholders (e.g. semantic tags such as PHP tags) for incorporating section view components, or any combination thereof. Thus, to generate UI instructions from a main viewer component 501, display engine 123 may need to perform a combination of calling routines and loading template files or strings.

At block 632, display engine 123 calls or loads one or more section viewer components, such as request UI components 502 and dynamic viewer components 503, to generate UI instructions to render one or more section UI components. For example, if the main display framework is implemented by an HTML template including PHP tags as placeholders for incorporating section viewer components, display engine 123, via PHP engine module (also referred to as “PHP preprocessor module”), calls or loads section viewer components corresponding to the PHP tags to generate HTML sections (UI instructions) used to render corresponding section UI components.

At block 633, display engine 123 incorporates generated UI instructions to render section UI components into generated UI instructions to render the main display framework, so as to generate UI instructions to render a final output UI (such as a UI for data submission in connection with block 602 or an output representation in connection with block 613).

Blocks illustrated in FIG. 6A-6D do not have to be performed or executed in the order shown in FIG. 6C. For example, block 622 may be performed after block 623 or block 624, and block 623 may be performed after block 624. Also, an illustrated block may comprise several sub-blocks, each of which may be performed at different times relative to other blocks or sub-blocks of other blocks. In fact, as far as execution time is concerned, sub-blocks of different blocks can be “intertwined” with each other. For example, block 622 may comprise several custom process sub-blocks 622A, 622B and 622C, each performing one or more separate tasks. Sub-block 622A may be performed before some sub-blocks of block 623 while sub-blocks 622B and 622C may be performed after some sub-blocks of block 623.

FIGS. 7A-D illustrate exemplary UIs and custom processing steps which the disclosed skill-rating system provides to implement user sign-up (registration) and sign-in, according to one or more embodiments of the present disclosure.

FIG. 7A shows an exemplary sign-up UI 700 which the disclosed skill-rating system provides for a user to sign up with backend system 102. As shown, sign-up UI 700 includes, inter alia, sign-up panel 701 as a section UI provided to allow the user to sign-up with backend system 102. Sign-up screen 700 may be provided to a user through the exemplary process and blocks shown in FIGS. 6A and 6D. For example, with respect to block 601, backend system 102 may receive the user's request for providing a sign-up UI via, e.g., the user typing the web site address of backend system at the address bar of the client application if the client application is a web browser. With respect to block 602, UI request handler 302 may map the request to, and call, sign-up/login UI component 521 as a section viewer component that provides sign-up panel 701 as the section UI to satisfy the request for sign-up UI.

Sign-up panel 701 allows a user to register with backend system 102 in two ways—namely, normal sign-up and social network sign-up. As shown, to use normal sign-up, the user may need to provide, in a sign-up form, data such as a name, an e-mail and a password, verified password, and an indication that the user agrees to the terms and conditions mandated by the disclosed skill-rating system, and finally click the “Register” button 711 to submit the data entered in the sign-up form.

The handling (processing) of a normal sign-up request by backend system 102 may be implemented by the exemplary processes and blocks illustrated in FIGS. 6B, 6C and 6D. For example, with respect to blocks 621-623, user request mapper 301 may map the user-submitted normal sign-up request to, and call, normal sign-up/login processor 303. Additionally, the custom processing performed by normal sign-up/login processor 303 may include, e.g., verifying whether the provided e-mail address has been used by another registered user, verifying whether the provided password and verified password match, and creating a new user account for the user. In creating the new user account, normal sign-up/login processor 303 may call one or more data model components 400, such as user profile model component 401, of data engine 122 to store data relating to the newly create user account (such as the user-submitted sign-up data and a newly created account ID identifying the user) in DS 111. With respect to blocks 613 and 614, following the user's submission of sign-up data, if the creation of a new user account is successful, backend system 102 may present to the user, via the client application, a newly created home page of the user's newly created account (as will be exemplified below), as if the user has just logged in with the correct login credentials.

To use social network sign-up, the user may click a button corresponding to signing-up using authentication from a specific social network provider (“SNP”), such as Facebook or LinkedIn. As shown, exemplary sign-up panel 701 includes two social network sign-up buttons—namely, buttons 712 and 713 for signing-up using authentication from Facebook and LinkedIn, respectively.

In one implementation, clicking a social network sign-up button, e.g., the “LinkedIn” button 713, results in an authentication dialog provided by LinkedIn and displayed in a pop-up window, as shown in FIG. 7C. Following the user's successful authentication into a SNP (such as LinkedIn), backend system 102 may be provided an authentication token by the SNP. The authentication token may then be used to retrieve from the SNP personal information and social networking information which the user registers with the SNP.

The handling (processing) of a social network sign-up request by backend system 102 may be similar to the handling of a normal sign-up request (except some custom processing specifically tailored to interacting with the SNP for authentication confirmation and importing of user data) and thus may also be implemented by the exemplary processes and blocks in FIGS. 6B, 6C and 6D. For example, with respect to blocks 621-623, user request mapper 301 may map the user-submitted normal sign-up request to, and call, social network sign-up/login processor 304. The custom processing performed by social network sign-up/login processor 304 may be exemplified by blocks illustrated in the flowchart shown in FIG. 7B.

Referring to FIG. 7B, at block 721, social network sign-up/login processor 304 provides instructions to the client application in accordance with instructions regarding authentication (for accessing social networking information) by a third party that the SNP provides to the public, such that the client application may launch an authentication UI that allows the user to authenticate himself/herself to the SNP.

At block 722, social network sign-up/login processor 304 receives an authentication token (which may also be referred to as a “session token”) from the SNP (via, e.g. a callback address of backend system 102 pre-registered with the SNP by backend system 102) if the user is successfully authenticated to the SNP.

At block 723, social network sign-up/login processor 304 uses the received token to obtain selected information of the user, such as personal information and skill-rating related information of the user, from the SNP using, e.g., application programming interfaces (API) provided by the SNP. Personal information of the user may include a specific ID that the SNP uses to identify the user. Skill-rating related information of the user may include information about user's skills, information about user's current and past employment, information about user's education, and social networking information of the user. Social network sign-up/login processor 304 creates a new user profile and a new account for the user using the information received from the SNP. In creating the new user account, normal sign-up/login processor 303 may call one or more data model components 400, such as user profile model component 401 and user skill model component 402, of data engine 122 to store data relating to the newly create user account, such as personal information and skill-rating related information of the use received from the SNP, in DS 111. The newly created user account may use one or more stored data entries indicating that the user account is created from sign-up using the SNP, so that the newly created user account may be distinguished from user accounts created from normal sign-up as well as user accounted created from sign-up using a different SNP.

FIG. 7D illustrates an exemplary section UI 761 (namely, login panel 761) which the disclosed skill-rating system provides for a user to sign up with backend system 102. Login panel 761 may be incorporated into a main display framework (not shown) as part of an output UI (not shown) present to the user. Login panel 761 may be provided (as part of an output UI) to a user through the exemplary processes and blocks illustrated in FIGS. 6A and 6D. For example, with respect to block 601, backend system 102 may receive a user's request for providing a login UI via, e.g., the user's clicking of “LOGIN” link 710 in sign-up UI 700 shown in FIG. 7A. With respect to block 602, UI request handler 302 may map the login request to, and call, sign-up/login UI component 521 as a section viewer component that provides login panel 761 as the section UI to satisfy the login UI request.

As shown, in one embodiment, login panel 761 includes “Login” button 762 for submitting normal login request and social network login buttons 763 and 764 each for submitting login request using authentication from a SNP. To submit normal login request, a user is prompted to provide an e-mail address (which was provided during registration and treated equivalent of a user name) and password as login credentials, and click the “Login” button 762 to submit the login credentials provided in login panel 761.

The handling (processing) of a normal login request by backend system 102 may be implemented by the exemplary processes and blocks illustrated in FIGS. 6B, 6C and 6D. For example, with respect to blocks 621-622, user request mapper 301 may map the user-submitted normal login request to, and call, normal sign-up/login processor 303. Additionally, the custom processing performed by normal sign-up/login processor 303 may include, e.g., determining whether the user's login is successful by verifying whether the provided login credentials (such as e-mail address and password) match the login credentials of the user stored in user profile DS 201. The custom processing may further include creating a session for the user if the user's login is successful.

With respect to blocks 624, normal sign-up/login processor 303 retrieves from data DS 111 user data required for forming a home page of the user (which may be presented to the user following the signing-in). Required user data may include complete sets or selected subset of profile data, follower data, skill-rating related activity data, group-related data, notification data and newsfeed data of or relating to the user. Thus, normal sign-up/login processor 303 may call data list components of data engine 122—such as user profile list component 441, user skill list component 442, rater/follower list component 443, activity list component 444, group-related list components 450, notification list component 448 and newsfeed list component 449—to retrieve the required user data.

With respect to blocks 613-614 and blocks 631-633 in connection with generating and presenting an output UI, if the user's login is successful, display engine is invoked to generate UI instructions to render a home page of the user's skill-rating account (as exemplified in FIGS. 8A-O), which incorporates section UIs showing skill-rating related data as well as enabling and facilitating the user to use various functionalities of the disclosed skill-rating system.

FIGS. 8A-O are pictorials illustrating examples of a user home page of the disclosed skill-rating system, according to one or more embodiments of the present disclosure. In particular, a user home page displays various skill-rating related data of the user, and enables and facilitates the user's use of the disclosed skill-rating system after the user logs into the system.

FIGS. 8A-I illustrate a first example of home page 810 of a user's skill-rating account. Referring to FIGS. 8A-I, as shown, home page 810 comprises a plurality of section UIs including header panel 811, profile panel 812, action link panel 813, follower/rater panel 815, group panel 816, activity panel 817, status panel 814 and newsfeed panel 818, which are further exemplified individually in FIGS. 8B-I, respectively.

Referring to FIG. 8B, header panel 811 is included in the home page to provide clickable links that let the user quickly view different types of skill-rating data and access various functions linked to the different types of skill-rating data. As shown, header panel 811 may include a plurality of clickable links, which include “Home” link 820, “Follower” link 821A, “Groups” link 822B, “My Skills” link 821C and “My Rating” link 821D. As will be further illustrated, these links allow user to quickly view different types of skill-rating data and access various functions linked thereto.

Referring to FIG. 8C, profile panel 812 is included in the home page to provide a condensed or summary view of the user profile as well as notifications which awaits the user to attend to. As shown, profile panel 812 may include a summary of a user profile, a clickable “Edit” link 825 that allows the user to view and edit the user's full profile, and a profile progress bar indicating how complete the user's profile is.

Profile panel 812 may further include a notification sub-panel 823, with which the user can respond to various skill-rating related notifications. In particular, notification sub-panel 823 may include a plurality of clickable icons each representing a different type of notification. These icons may include icon 824A representing global notifications, icon 824B representing follower invitation notifications, and 824C representing rating request invitation notifications. As shown, a number-icon showing number “1” is partially overlaid onto icon 824A, alerting the user that there is “1” outstanding rating-request invitation that is still awaiting the user to attend to. Thus, a number-icon may be partially overlaid onto a notification-type icon to alert the user of the number of outstanding notices (which are of the notification type that the icon represents) that still await the user to attend to.

Referring to FIG. 8D, action link panel 813 is included in the home page to provide the user with shortcuts for submitting a few common skill-rating related action requests. As shown, action link panel 813 may include a plurality of clickable action links provided to facilitate the user to submit an action request to backend system 102 with associated action data. Clicking each of the action links results in a corresponding UI displayed to allow the user to submit one or more corresponding action requests with the action data entered in the UI. Specifically, among the plurality of action links, the “Pending Requests” link 822A is provided to facilitate the user to submit a request to register details of one or more ratings provided in response to one or more pending rating requests. The “Request Rating” link 822B is provided to facilitate the user to create and submit a rating request with associated rating request data. The The “Add A Skill” link 822C is provided to facilitate the user to submit a request to add a custom or default skill. The “Add A Follower” link 822D is provided to facilitate the user to submit a request to add one or more followers. The “Add Group” link 822E is provided to facilitate the user to submit a request to add one or more groups.

Referring to FIG. 8E, status panel 814 is included in the home page to provide user with access to miscellaneous skill-rating related functionalities. As shown, status panel 814 may include a plurality of tabs, each of which, when selected, provides there-under a UI subpanel that allows the user to perform one or more skill-rating related functions corresponding to the label of the tab. Specifically, status panel 814 may include a “STATUS” tab facilitating the user to post the user's status information to a skill-rating social network of the user (including, e.g., followers and/or raters of the user), an “ASK QUESTION” tab facilitating the user to post a question to a skill-rating social network of the user, a “REQUEST RATING” tab facilitating the user to issue a rating request, and an “ANSWER RATING” tab facilitating the user to answer one or more outstanding rating requests received from one or more other users in a skill-rating social network of the user.

Referring to FIG. 8F, follower/rater panel 815 is included in the home page to provide a condensed or summary view of follower and rater information of the user and let user have quick access to follower/rater related functionalities. As shown, follower/rater panel 815 may include a plurality of clickable images of the user's followers and raters, a “View all” link 841, and an “Add Followers” button 840. Clicking an image of a follower or rater leads to the displaying of profile and skill-rating related data of the follower or rater, and thus allows the user to view the same. Clicking the “View all” link 841 may result in displaying of a UI of an expanded viewing area through which the user can get access to the profile and skill-rating related data of all the users. Clicking the “Add followers” button 840 results in displaying of a UI that allows the user to add one or more followers, as will be further demonstrated.

Referring to FIG. 8H, group panel 816 is included by the home page to provide a condensed or summary view of group information of the user and let the user have quick access to group related functionalities. As shown, group panel 816 may include a plurality of sub-panels 830 each dedicating to a particular group with which the user is associated. Each sub-panel comprises a plurality of UI items arranged in accordance with a pre-defined layout. The UI items may include a clickable image showing, e.g., a logo of the organization that the group corresponds to, a partial or abbreviated name of the group, a clickable link having text showing the number of the members of the group, and a clickable “Statistics” button 831. If the user has the permission to manage the group, a sub-panel 830 may include a clickable “Manage” button 832. Clicking a UI item included in the sub-panel may lead to an expanded UI allowing user to view or edit group data related to the UI item and/or access group-related functionalities related to the UI item. For example, clicking the “Manage” button 832 of a sub-panel 830 may result in displaying of a UI allowing the user to perform various group management functionalities. Clicking the “Statistics” button 831 may result in displaying of a UI letting the user view various statistical data associated with the group (such as week over week growth in group membership, or number of group discussions from month to month).

Group panel 816 may further include a “Show all” link 833 and an “Add Group” button 834. Clicking the “Show all” link 841 may result in displaying of a UI of an expanded viewing area through which the user may view or edit data of all the groups of the user. Clicking the “Add Group” button 834 results in displaying of a UI that allows the user to add one or more groups, as will be further demonstrated.

Referring to FIG. 8H, activity panel 817 is included in the home page to provide a condensed or summary view of information about used-for-skill-rating activities of the user and let the user have quick access to activity-based rating data of the user. As shown, activity panel 817 may include a plurality of sub-panels 850 each dedicating to a particular used-for-skill-rating activity created by a user via creating a rating request. Each sub-panel may include a clickable link 851 with its text showing the title or the partial title of the dedicated activity as well as the description or partial description of the dedicated activity. Clicking link 851 may result in displaying of a UI allowing the user to view rating data associated with the dedicated activity as well as giving the user access to one or more functionalities associated with the dedicated activity (such as inviting more socially connected users to rate skills linked to the activity).

Activity panel 817 may further include a “View all” link 851. Clicking the “View all” link 851 may result in displaying of a UI of an expanded viewing area through which the user may view information related to all of the used-for-skill-rating activities of the user (including rating data on skills linked to each activity) and gain access to functionalities associated with the activity.

Referring to FIG. 8I, newsfeed panel 818 is included in the home page to provide a condensed or expanded view of newsfeed related to the user. As shown, newsfeed panel 818 includes a plurality of sub-panels 860, each of which is dedicated to a news entry. Each sub-panel 860 includes a narrative 861 of the news entry, to which the sub-panel. The narrative 861 may include clickable name and image links of an actor user, the text describing a skill-rating related action that the actor has performed, and a clickable name link of target user on which the action is performed. Clicking the name link or the image link may result in displaying of a UI showing profile and skill-rating related data of the actor user. A subpanel 860 may provide one or more UI elements that allow the user to react to the action that the actor performed. Thus, as shown, one subpanel 860 provides UI elements 863A and 863B that allow the user to post a comment. If the action involved in a news entry (listed in a subpanel) is rating on one or more skills of the target user based on an activity, the subpanel may further include a UI showing detail data of the ratings. Additionally, the subpanel 860 may include clickable action links, such as action links 864A, 864B and 864C, which allow the user to “like” the rating, view the “360-degree” spider chart of the rating, and share the rating in social media (such as well-known social networks Facebook and LinkedIn), respectively.

FIGS. 8J-O illustrate a second example of home page 810 of a user's skill-rating account. Referring to FIGS. 8J-O, as shown, the second exemplary home page 810 also comprises a plurality of corresponding section UIs including header panel 811, profile panel 812, action link panel 813, group (team) panel 816, status panel 814 and newsfeed panel 818.

By way of example and not limitation, as shown, hovering a mouse over the “RATINGS” UI element 821G of header panel 811 may result in a display of a drop-down menu (exemplified in FIG. 8K) having menu items 871 relating to displaying of relating to rating data or rating request data of the user. Clicking the “Rate Now” button 822F of action link panel 813 may result in displaying of UI 872 (exemplified in FIG. 8L), which facilitates the user to rate on pending user rating requests and pending group (team) rating requests. Clicking the “Collaborate” button 822G of action link panel 813 may result in displaying of UI 873 (exemplified in FIG. 8M), which facilitates a user to perform actions relating to collaborating with other networked users (such as raters), such as commenting on one or more ratings associated with the user. Clicking the “Requested Feedback” and “Answered Feedback” UI links may respectively result in displaying of UIs 874 and 875 (e.g. in newsfeed panel 818), which facilitate the user to view and act on, e.g., incoming and outgoing rating requests of the user. In particular, context clickable icons 882A and 882B may be displayed when the user hovers a mouse over a listed rating request entry, enabling the user to, e.g., expand the rating request entry (for viewing more detailed information about the corresponding rating request) or archive the corresponding rating request.

The provision of home page 810 may be implemented using the process and blocks illustrated in FIGS. 6B, 6C and 6D (in connection with handling an action request). In particular, with respect to block 611 of FIG. 6B, the client application or backend system 102 may receive an action request to return a home page of a user as a result of the successful login of the user or the user's clicking of “Home” link 820. With respect to block 612 of FIG. 6B and block 624 of FIG. 6C, processing engine 121 calls data list components 440 to retrieve skill-rating related data (such as activity data, user profile data, notification data, group data, follower data, and newsfeed data) required by home page 810 for display. With respect to block 631 of FIG. 6D, processing engine 121 calls or loads a main viewer component 501 adapted to generate UI instructions to render a main display framework specifically designed and laid out for home page 810. With respect to block 632 of FIG. 6D, processing engine 121 calls or loads dynamic viewer components 503 of display engine 123 adapted to generate UI instructions to render section UIs (such as header panel 811, profile panel 812, action link panel 813, follower/rater panel 815, group panel 816, activity panel 817, status panel 814 and newsfeed panel 818) laid out in the main display framework with retrieved skill-rating related data. With respect to block 633 of FIG. 6D, processing engine 121 calls display engine 123 to incorporate generated UI instructions to render section UIs into generated UI instructions to render the main display framework to generate UI instructions to render home page 810.

FIGS. 9A-B illustrate exemplary section UIs which the disclosed skill-rating system may provide for letting the user add a skill, according to one or more embodiments of the present disclosure.

FIG. 9A shows a first example of such a UI. As shown, section UI 900 (which can be incorporated into a main display framework) may include input fields 902 and 903 for entering a skill title and skill description, respectively. Section UI 900 may also include a UI selector 904 for selecting a skill category for the to-be-added skill from a list of available default skill categories. If the desired skill category for the to-be-added skill cannot be found from the list of available default skill categories, the user may use input field 905 (which appears if “other” is selected in UI selector 904) to enter a custom skill category. FIG. 9B shows a second example of a UI 900 in an embodiment where a skill is not required to be linked to or otherwise associated with a skill category.

The provision of section UI 900 may be implemented using the process and blocks illustrated in FIGS. 6A and 6D (in connection with providing a UI in response to a UI request). In particular, with respect to block 601 of FIG. 6A, the client application or backend system 102 my receive from the user a UI request for adding a skill as a result of clicking “Add A Skill” link 822C (of home page 810). With respect to block 632 of FIG. 6D, user skill creation UI component 524 of display engine 123 may be called to generate UI instructions to render section UI 900.

Clicking the “submit” button 906 causes an action request to add a skill, along with associated data (which may include the skill title, skill description and skill category provided via section UI 900), to be sent to backend system 102. Specifically, receiving of the action request by backend system 102 triggers a process of handling the action request exemplified by blocks illustrated FIGS. 6B, 6C and 6D. In particular, with respect to block 621, skill-related submission processor 323 may be invoked to process the action request to add a skill With respect to block 623, skill model component 407 may be invoked to create one or more new data records (reflecting the addition of a skill) and store the user-submitted skill data corresponding to the newly added skill, in one or more component data store of DS 111 (such as skill DS 207) so as to effectuate the addition of a skill

FIGS. 10A-H illustrate exemplary UIs that the disclosed skill-rating system may provide to allow a user to add one or more followers or raters, according to one or more embodiments of the present disclosure.

FIGS. 10A-G shows an exemplary tabbed section UI 1000 which the client application or backend system 102 provides using the process and blocks illustrated in FIGS. 6A and 6D in connection with providing a UI in response to a UI request. In particular, with respect to block 601 of FIG. 6A, the client application or backend system 102 may receive the user's UI request (which results in displaying of a section UI 1000) resulting from the user's clicking “Add Follower” button 840. With respect to block 632 of FIG. 6D, follower invitation UI component 523 may be called to generate UI instructions to render section UI 1000.

Section UI 1000 (which may also be referred to as “follower selector 1000”) allows a user to select one or more potential follower (for invitation) from different social networking sources. As exemplified in FIGS. 10A, 10B, 10C, 10D, 10E, 10F and 10G, the user may select or otherwise provide one or more potential followers or raters from (a) system users already registered with the disclosed skill-rating systems (such as users from skill-rating groups with which the user is associated), (b) member users in groups of which the user is a member, (c) social networks with which the user is affiliated, (d) email addresses collected from an existing e-mail account of the user, and (e) email addresses directly provided by the user. A “selected” subpanel 1001 (shown in FIG. 10A) may be provided (as part of UI 1000) to indicate and de-select users whom have been selected. After selecting the potential followers from one or more different networking sources, the user may submit to backend system 102, via, e.g., a submit button (not shown), an action request to invite selected potential followers or raters to be followers or raters of the user (with the invitation data collected through selections made via section UI 1000 as exemplified in FIG. 10A-10G).

Receiving of the action request by backend system 102 triggers a process of handling the action request exemplified by blocks illustrated FIGS. 6B, 6C and 6D. In particular, at block 621, follower-related submission processor 324 may be invoked to process the action request to invite selected potential followers. With respect to block 622, in the first scenario, follower-related submission processor 324 may send a follower invitation notification to each selected invitee who is already a registered user (by, e.g., calling notification model component 408 to store a follower invitation notification linked to the selected invitee user). These invitees may have been selected via the selection user interface illustrated in FIGS. 10A and 10B. Optionally, follower-related submission processor 324 may also send an e-mail to each selected invitee user to inform the invitee user of an outstanding follower invitation from the user. In the second scenario, follower-related submission processor 324 may send an invitation to each selected invitee who is associated with the user via one or more SNPs, such as Facebook or LinkedIn, via invitation schemes provided by SNPs, and document the sending of the invitation (via, e.g., DS 111). These invitees may have been selected via the selection user interface illustrated in FIG. 10C. In the third scenario, follower-related submission processor 324 may send an e-mail invitation to each e-mail invitee via the invitee's e-mail address, and document the sending of the invitation (via, e.g., DS 111). These invitees may have been selected via the selection user interface illustrated in FIGS. 10D-G.

With respect to the first scenario, a selected invitee user receives (or, in other words, becomes aware of) via an alert number icon (indicating the number of outstanding invitation notifications) overlaid onto icon 824B of notification sub-panel 823 when the invitee user logs into home page. The clicking of icon 824B or the alert number icon may result in displaying of a notification sub-panel 1011 as a section UI, as exemplified by FIG. 10H. The provision of notification sub-panel 1011 as a section UI for responding to follower invitation may be provided to a user through the exemplary process and blocks shown in FIGS. 6A and 6D. In particular, with respect to block 601, the client application or backend system 102 may receive a UI request for providing a UI to respond to one or more invitation notifications as a result of the user's clicking icon 824B or the alert number icon. With respect to block 632, UI request handler 302 may map the request to, and call, notification response UI component 528 as a section viewer component to generate UI instructions to render notification sub-panel 1011.

The clicking of icon 824B or the alert number icon may result in displaying of a UI, as exemplified by FIG. 10H, which allows the invitee user to either indicate acceptance of the follower invitation via clicking of “Accept” button 1012 or indicate rejection of the follower invitation via clicking “reject” link 1013. In particular, the clicking of “Accept” button 1012 results in the invitee user's submission of an action request to accept the user's follower invitation. Receiving of the action request by backend system 102 triggers a process of handling the action request exemplified by blocks illustrated FIGS. 6B, 6C and 6D. With respect to block 623, follower-related submission processor 324 may call user relationship component model 403 to update one or more components of DS 111 (such as user relationship DS 203) so as to effectuate that the invitee user becomes a follower of the user.

With respect to the second and third scenarios, some or all of the invitee may decide to join the disclosed skill-rating system by going through the registration and login processes exemplified in FIGS. 7A-D. Since, as noted above, the earlier sending of a follower invitation was documented, following an invitee's joining of the disclosed skill-rating system, the invitee may receive a follower invitation notification (similar to the follower invitation notification which an invitee user receives in the first scenario) in the invitee's home page of the skill-rating system. The invitee may then follow the same set of steps described above in connection with the first scenario to effectuate the invitee's becoming a follower of the user within the skill-rating system.

FIGS. 11A-F illustrate exemplary UIs that the disclosed skill-rating system may provide to enable a user to create and send out a rating request and perform self-rating, and enable the invitee users to answer an incoming rating request (sent out by another user), according to one or more embodiments of the present disclosure.

FIG. 11A shows a first example of section UI 1100 through which a user can create and send out a rating request to other users so that other users may rate on certain skills of the user associated with certain activities. Referring to FIG. 11, section UI 1100 may include a rating type selector 1101, activity title input field 1102, activity description input field 1103, skill selector 1104, skill-selection result box 1107, rater selector 1000, permission selector 1109, and “Send Invitation” submit button 1110.

Rating type selector 1101 allows the user to select a type of the rating request. Possible rating request types may include “normal rating request” and “public rating request”. For rating request not related to a public performance, usually the “normal rating request” type is selected.

Activity title input field 1102 and activity description input field 1103 let user to define an activity which a feedback (including appreciation) as well as ratings on the user's skills are based off or linked to. Activity title input field 1102 lets us enter a title for the activity and activity description input field 1103 lets user enter a description for the activity. In many cases, the defined activity is a “medium” or a concrete context, through or during which the user's one or more skills have been demonstrated to others.

Skill selector 1104 is configured to let user select one or more skills of the user, which the user wants other users to rate, based on what the user has demonstrated in the defined activity. Skill selector 1104 comprises category pane 1105 and skill pane 1106. Category pane 1105 lists a plurality of skill categories of which a user can select a single skill category. Skill pane 1106 lists skills which belong to a contemporaneously selected single skill category. Skill pane 1106 allows a user to select one or more listed skill by letting user check the check box next to a skill which the user wants to select. In particular, skill pane 1106 may also include an expandable “my group” item, which, when expanded, lists all the groups of the user. When the user selects a group from the group list (in the category pane 1105), group skills of the selected group are listed in the skill pane 1106 for selection. Through this mechanism, the user may also select group skills of one or more groups of the user's. The group skill selection mechanism will be further illustrated below in connection with subject matter relating to creating public rating request and collecting public ratings. Additionally, skill selector 1104 may also provide clickable links 1111 and 1112 allowing the user to contemporaneously add a new skill (without being limited to a skill category) and add a skill to a selected category, respectively, as the user creates the rating request. Adding new skills through clickable links 1111 and 1112 may be implemented in ways similar to what has been described above in connection with adding a skill with reference to FIG. 9A or FIG. 9B. Optionally, skill selector 1104, as a programmatic object, may limit the number of skills that the user may select for rating.

Skill-selection result box 1107 lists skills (including group skills) that have been selected by the user. Each list item (indicating a corresponding selected skill) also has an “x” icon clicking of which results in deletion of the item and thus the deletion of the corresponding skill from the list of selected skills. Thus, with maneuvering on skill selector 1104 and skill-selection result box 1107, the user can finalize a list of selected skills.

Rater selector 1000, which is of the same or similar nature to follower selector 1000 exemplified in FIGS. 10A-G, allows the user to select potential raters whom the user would like to respond to the rating request. Permission selector 1109 allows the user to define the permission setting (or, in other words, the visibility level) in connection with showing the eventual ratings. Possible permission setting may include “Public” or one of similar nature, “Followers” (or “Raters”) or one of similar nature, “My Groups” (or “My Teams”) or one of similar nature, “Only me” or one of similar nature, and “Completely private (Raters identity would not be disclosed)” or one of similar nature. In one embodiment, a permission setting may be viewed as a visibility setting defining who may see or otherwise access the rating request and ratings received or otherwise provided on the rating request.

FIG. 11B illustrate a second example of section UI 1100 through which a user can create and send out a rating request to other users. Specifically, the second exemplary UI 1100 can only be used to create a normal rating request, as no rating type selector is provided therein. Also, skill selector 1104 does not include a category pane 1105, as a skill may not be required to be linked to or otherwise associated with a skill category in an embodiment where the second exemplary UI 1100 is utilized. Additionally, skill selector 1104 includes a “Personal Skill” tabbed panel where personal skills of the user can be selected as well as “a “Team Skill” tabbed panel (exemplified in FIG. 11C) where individual groups of the user are listed and group skills of one or more listed individual groups of the user can be selected (through, e.g., expanding respective subpanels of listed individual groups included therein).

The provision of section UI 1100 may be implemented using the process and blocks illustrated in FIGS. 6A and 6D (in connection with providing a UI in response to a UI request). In particular, with respect to block 601 of FIG. 6A, the client application or backend system 102 my receive from the user a corresponding UI request as a result of the user clicking the “Request Rating” link 822B. With respect to block 632 of FIG. 6D, rating request UI component 522 of display engine 112 may be called to generate UI instructions to render section UI 1100.

The user's clicking of “Send Invitation” button 1110 causes an action request to create a rating request to be submitted to backend system 102 along with the rating request data provided via UI elements in section UI 1100 (such as rating type selector 1101, activity title input field 1102, activity description input field 1103, skill selector 1104, skill-selection result box 1107, rater selector 1000 and permission selector 1109). Thus, the provided rating request data includes the rating type selected, the title and description entered for the activity (which the rating request is based off), the skills selected, the potential raters selected, and the permission setting selected.

Receiving of the action request to create a rating request by backend system 102 triggers a process of handling the action request exemplified by blocks illustrated FIGS. 6B, 6C and 6D. In particular, with respect to block 621, rating-request submission processor 321 may be invoked to process the action request (to create a rating request). With respect to block 623, activity model component 404 of data engine 112 may be invoked to create one or more new data records (reflecting the creation of a new activity for the skill-rating purpose) and store the user-submitted data corresponding to the new activity (such as the title and description thereof), in one or more component data stores of DS 111 (such as activity DS 204). Additionally, rating request model component 405 may be invoked to create one or more new data records (reflecting the creation of a new rating request) and store the user-submitted data corresponding to the new rating request (such as selected rating request type and selected skills), in one or more component data stores of DS 111 (such as rating request DS 205). With respect to block 622, rating invitations or rating invitation notifications are sent or provided to invitees (potential raters) selected via rater selector 1104. The sending of rating invitations or providing of rating invitation notifications are implemented in ways similar to what have been described with respect to implementing the sending of follower invitations or providing of follower invitation notifications.

In one embodiment, following the clicking of “Send Invitation” button 1110, the user may be presented a self-rating UI 1130 which enables the user to do a self-rating on the rating request just created. In one embodiment, the self-rating UI 1130 may be included in rating-request creation UI 1100 in such a manner that a rating request cannot be submitted (and thus created) if the user does not first perform a self-rating (using the included UI 1130) on the intended rating request.

Following the provision of a rating invitation notification (resulting from the submitted rating request) to a selected invitee user (who is registered with backend system 102), the selected invitee user receives (or, in other words, becomes aware of) via an alert number icon (indicating the number of outstanding invitation notifications) overlaid onto icon 824C of notification sub-panel 823 when the invitee user logs into home page. The clicking of icon 824C or the alert number icon may result in displaying of a notification panel 1120 as a section UI, as exemplified in FIG. 11D. The invitee user's subsequent clicking of the “Rate now” button 1121 results in displaying of a section UI (as part of a display UI) for answering the rating request, as exemplified by section UI 1140 shown in FIG. 11C.

Section UI 1140 includes text item 1141 identifying the ratee (the user who creates the rating request and invites the invitee user to provide feedback and ratings on skills), text item 1151 identifying the permission setting selected by the ratee, and text item 1142 identifying the activity which is defined in the rating request and which the feedback and ratings on the skills, as to be provided by the invitee user (rater), should be based off. Section UI 1140 further includes relationship selector 1143, appreciation input field 1144, skill rating panel 1145, advice input field 1146 and resource input field 1147 for entering data relating to a rating.

Relationship selector 1143 lets the rater select a relationship between the rater and the ratee. By way of example and not limitation, possible relationships may include “Manager/Boss” or one of similar nature, “Peer” or one of similar nature, “Direct Report” or one of similar nature, “Internal Customer” or one of similar nature, “External Customer” or one of similar nature, and “other”. Appreciation input field 1144 lets the rater provide the rater's appreciation in connection with the ratee's effort and performance demonstrated in the defined activity. Thus, the rater is given an opportunity to express appreciation to the ratee in connection with the defined activity regardless of how the rater rates the ratee on skills. Skill rating panel 1145 lets the rater provide a rating on each and every skill listed therein. Advice input field 1146 lets the rater provide the rater's advice in connection with the defined activity. Resource input field 1147 lets the rater provide a URL link having content that may help the ratee get better in, e.g., future performance in connection with the defined activity or other future activities. Clicking the “attach” button 1148 will yield a summary, title or brief description of the content 1149 (using, e.g., one or more known client-side scripting technologies which achieves asynchronous content retrieval, such as Ajax). Thus, with the section UI 1140, the feedback and rating data in connection with the defined activity, as provided by the rater, may include the appreciation, the advice, the ratings of skills, and the URL link.

The provision of section UI 1140 may be implemented using the process and blocks illustrated in FIGS. 6A and 6D (in connection with providing a UI in response to a UI request). In particular, with respect to block 601 of FIG. 6A, the client application or backend system 102 my receive from the user a corresponding UI request as a result of the invitee user clicking the “Rate now” button 1121 in notification panel 1120 (shown in FIG. 11B). With respect to block 632 of FIG. 6D, rating provision UI component 525 of display engine 112 may be called to generate UI instructions to render section UI 1140.

The rater's clicking of “Submit rating” button 1150 causes an action request to create a rating to be submitted to backend system 102 along with associated data, which, inter alia, includes the provided feedback and rating data.

Receiving of the action request (to create a rating) by backend system 102 triggers a process of handling the action request exemplified by blocks illustrated FIGS. 6B, 6C and 6D. In particular, with respect to block 621, rating submission processor 322 may be invoked to process the action request (to create a rating request). With respect to block 623, rating model component 404 of data engine 112 may be invoked to create one or more new data records (reflecting the creation of a new rating) and store the provided feedback and rating data corresponding to the defined activity, in one or more component data stores of DS 111 (such as rating DS 206).

FIGS. 12A-K illustrates exemplary UIs that the disclosed skill-rating system provides to implement group-related skill-rating functions, according to one or more embodiments of the present disclosure.

In on embodiment, with the disclosed skill-rating system, only users having a premium membership may be allowed to create a group. FIG. 12A shows an exemplary section UI 1200 which the client application or backend system 102 may provide to let a user add a group. The provision of section UI 1000 may be implemented using the process and blocks illustrated in FIGS. 6A and 6D (in connection with providing a UI in response to a UI request). In particular, with respect to block 601 of FIG. 6A, the client application or backend system 102 may receive from the user a UI request (which results in displaying a UI including section UI 1200) as a result of clicking “Add Group” button 834. With respect to block 632 of FIG. 6D, group creation UI component 523 of display engine 122 may be called to generate UI instructions to render section UI 1200.

As shown, to create a group, the user may need to provide group name via input field 1202 and provide group description via input field 1203. Optionally, the user may need to specify one or more settings relating to notifications (such as new member notification, join request notification, and wall post notification). Clicking the “Add Group” button 1201 causes an action request to add a group, along with user-entered data relating to group creation (such as user-entered group title, group description as well as settings relating to notifications), to be sent to backend system 102. The action request may be processed by backend system 102 through the process and blocks illustrated in FIGS. 6B, 6C and 6D, resulting in a new group created for the user and added to the user's group list.

Specifically, receiving of the action request by backend system 102 triggers a process of handling the action request exemplified by blocks illustrated FIGS. 6B, 6C and 6D. In particular, with respect to block 621, group-related submission processor 324 may be invoked to process the action request to create a new group with the user being the creator. With respect to block 623, group-related submission processor 324 may call group profile model component 421 of data engine 122 to store user-entered data relating to group creation in one or more component DS of DS 111 so as to effectuate the group creation.

FIG. 12B shows an exemplary section UI 1210 which the disclosed skill-rating system may provide (via the client application) to let a user have an expanded view of information about a list of groups (teams) with which the user is associated.

Section UI 1210 is hereinafter referred to as group list panel 1210 since the section UI is used to display information about a list of groups with which the user is associated. As shown, group list panel 1210 comprise a plurality of subpanels 1211 each dedicating to a group of the user. Each subpanel 1211 comprises UI elements showing the title and the description of the group (to which the subpanel is dedicated). Each subpanel may also include a clickable “Manage” button (or link) that allows the user to manage of the group if the user has the permission to manage the group (to which the subpanel is dedicated). Additionally, group list panel 1210 may also include UI elements that may be used to reconfigure displaying of group data. For example, group list panel 1210 may include links 1213 and 1214 that may be used to change the listing order of the user's group based on different sorting criteria.

The provision of group list panel 1210 may be implemented using the process and blocks illustrated in FIGS. 6B, 6C and 6D (in connection with handling an action request). In particular, with respect to block 611 of FIG. 6B, the client application or backend system 102 my receive from the user an action request to view and access data about all groups of the user as a result of clicking the “View all” link 833. With respect to blocks 621 of FIG. 6C, group-related data request processor 346 of processing engine 121 may be called to process the action request. With respect to blocks 624 of FIG. 6C, group-related data request processor 346 may call user group list component 466 and group profile list component to retrieve data about groups of the user for display (in, e.g., group list panel 1210). With respect to block 632 of FIG. 6D, user group list viewer component 586 of display engine 122 may be called to generate UI instructions to render group list panel 1210.

FIGS. 12C-E illustrate exemplary UIs which the disclosed skill-rating system may provide (via the client application) to let a user manage members of a group as well as enable the user to invite another user to be a member of the group.

FIG. 12C shows an exemplary section UI 1220 through which a user can manage a featured group. In particular, section UI 1220 is specifically laid out and rendered to provide the user with quick accesses to functions and options relating to group management. For example, in the right side viewing area, section UI 1220 includes panels that give the user quick access to administrative options (such as inviting group members via clickable option link 1226 and adding group skills via clickable option link 1227), functions to create groups and discussions, options to view all group information, and functions to view group statistics.

In particular, section UI 1220 includes a panel 1224 where an image (which may be a logo), a title and a description of the featured group are displayed. Section UI 1220 further includes a group tab panel 1221 that allows the user to view or edit a different type of group data when a different tab is selected as the active tab. In FIG. 12C, the “Live Stream” tab is selected as the active tab of group tab panel 1221. Thus, the main viewing area of group tab sub-panel 1221 becomes a group bulletin tab UI 1261 dedicated to UI elements provided to let the user view the “live stream” of bulletin message of the featured group.

As shown, bulletin tab UI 1261 may include a subpanel 1262 having input field 1263 and clickable “Share” button 1264 that collectively enable the user post a bulletin message so that a new thread of bulletin messages can be created. Bulletin tab UI 1261 may also include a list of one or more thread subpanels 1265 each for letting the user view an existing thread of group bulletin messages. Specifically, each thread subpanel 1265 may include lead message item 1266, one or more follow-up message items 1267, and comment-posting items including input field 1268 and clickable “Post Comment” button 1269.

The provision of group bulletin tab UI 1261 may be implemented using the process and blocks illustrated in FIGS. 6B, 6C and 6D (in connection with handling an action request). In particular, with respect to block 612 of FIG. 6B, the client application or backend system 102 my receive from the user an action request to view group bulletin messages as a result of clicking the “Live Stream” tab of group tab panel 1221 or clicking the “Teams” link 821T of header panel 811 of home page 810 (when the “Live Stream” tab is set as the default selected tab of group tab panel 1221). With respect to block 621 of FIG. 6C, group-related data request processor 346 of processing engine 121 may be called to process the action request. With respect to block 624 of FIG. 6C, group-related data request processor 346 may call group bulletin list component 464 to retrieve for display member data for the particular group. With respect to block 632 of FIG. 6D, bulletin list viewer component 584 of display engine 122 may be called to generate UI instructions to render group bulletin tab UI 1261.

If the user tries to post a group bulletin message (so as to create a new message thread by clicking “Share” button 1264 (after entering text via input field 1263), or tries to post a comment linked to a message thread by clicking “Post Comment” button 1269 (after entering text via input field 1268), the clicking of either button 1264 or button 1269 causes an action request (to either post a group bulletin message or post a comment linked to a message thread) to be submitted to backend system 102 along with the message or comment data which the user entered via input fields 1263 or 1268.

Receiving of the action request by backend system 102 triggers a process of handling the action request exemplified by blocks illustrated FIGS. 6B, 6C and 6D. In particular, with respect to block 621, group-related submission processor 325 may be invoked to process the action request to either post a group bulletin message or post a comment linked to a message thread. With respect to block 623, group-related submission processor 324 may call group bulletin model component 424 to create one or more new data records (reflecting the posting of a new bulletin message and the starting of a new message thread or the posting of a new comment linked to an existing message thread) and store the user-submitted message or comment data corresponding to the newly created one or more data records, in one or more component data stores of DS 111 (such as group bulletin DS 224), so as to effectuate the posting of new bulletin message and the starting of a new message thread or the posting of a new comment linked to an existing message thread. To update or refresh the display of bulletin tab UI 1261 (so as to reflect either the posting of new bulletin message or the posting of a new comment linked to an existing message thread), with respect to block 624, group bulletin list component 464 may be called to retrieve for display updated bulletin data (including threads and messages) for the featured group. Additionally, with respect to block 632 of FIG. 6D, group bulletin list viewer component 584 of display engine 122 may be called to generate UI instructions to render the updated or refreshed bulletin tab UI 1261.

FIGS. 12D and 12E show exemplary UIs through which a manager user (administrator) of a group can select and send member invitation to an invitee user and the invitee user can accept the invitation to become a member of the group. FIG. 12D shows an exemplary section UI 1230 configured to allow a manager user of a group to select and send member invitation to one or more invitee users. Specifically, section UI 1230 includes an upper panel 1231 containing UI items identifying a featured group, a middle panel containing member selector 1000 for selecting and sending member invitation to one or more invitee users, and a lower panel containing a message box 1235. The manager user may use the member selector 1000 to select and add invitee users. The manager user may enter a personal invitation message to the selected invitees using message box 1235.

Clicking the “Send Invitations” button 1232 causes an action request to invite members to be submitted to backend system 102 along with member invitation data provided by member selector 1000. Receiving of the action request by backend system 102 triggers a process of handling the action request exemplified by blocks illustrated FIGS. 6B, 6C and 6D. In particular, with respect to block 621, group-related submission processor 325 may be invoked to process the action request to invite selected potential members to join the featured group. With respect to block 622, group-related submission processor 324 may send a member invitation notification to each selected invitee user (as determined from the member invitation data) (by, e.g., calling notification model component 408 to store a member invitation notification linked to the selected invitee user). Optionally, group-related submission processor 325 may also send an e-mail to each selected invitee user to inform the invitee user of an outstanding member invitation from the manager user.

A selected invitee user may receive (or, in other words, become aware of) a member invitation notification via an alert number icon (indicating the number of outstanding invitation notifications) overlaid onto icon 824B of notification sub-panel 823 when the invitee user logs into home page. The clicking of icon 824B or the alert number icon may result in displaying of a notification sub-panel 1236, as exemplified by FIG. 12E. The provision of notification sub-panel 1236 as a section UI for responding to a member invitation may be implemented in a manner similar to what has been described above with respect to the implementation of the provision of notification sub-panel 1011 as a section UI for responding to a follower invitation.

Notification sub-panel 1236 allows the invitee user to accept the member invitation via clicking of “Accept” button 1237 included therein. The clicking of “Accept” button 1237 results in the invitee user's submission of an action request to accept the manager user's invitation. Receiving of the action request by backend system 102 triggers a process of handling the action request exemplified by blocks illustrated FIGS. 6B, 6C and 6D. With respect to block 623, group-related submission processor 325 may call group member model component 422 to create one or more new data records (reflecting the addition of a member to the featured group) in one or more component data stores of DS 111 (such as group member DS 223) and update the one or more component data stores, so as to effectuate the addition of the invitee user to the member list of the featured group.

The removal of a selected member user from the featured group (as triggered by the clicking of “Remove” link 1225 shown in FIG. 12K) may be implemented using processing steps similar to those described above in connection with adding an invitee user to the featured group, except that one or more component data stores of DS 111 (such as group member DS 223) are updated to reflect that the selected member user is removed from the member list of the featured group.

FIGS. 12F-G shows exemplary UIs which the disclosed skill-rating system may provide to let a user view or manage existing group skills of a group and add a group skill to the group's list of group skills.

In particular, the “skills” tab is selected as the active tab of group tab panel 1221. Thus, the main viewing area of group tab sub-panel 1221 becomes a “skill tab UI” 1241 dedicated to UI elements provided to let the user view or edit group skills of the featured group. As shown, skill tab UI 1241 comprises a list of sub-panels 1242 each for viewing or editing data regarding a group skill of the group. In particular, each sub-panel 1242 comprises clickable icons 1243 and 1244 for removing and editing data about the group skill (for which the sub-panel is displayed), respectively.

The provision of skill tab UI 1241 may be implemented in a manner similar to what has been described with respect to the implementation of the provision of bulletin tab UI 1261 with some exceptions in data list component(s) and dynamic viewer component(s) called. In particular, with respect to block 624, group-related data request processor 346 may call group skill list component 463 to retrieve for display group skill data for the featured group. Additionally, with respect to block 632 of FIG. 6D, group skill list viewer component 583 of display engine 122 may be called to generate UI instructions to render skill tab UI 1241.

FIG. 12G shows an exemplary UI 1250 through which a manager user of a group can add a group skill (team skill) to the group's list of group skills (team skills). Specifically, UI 1250 may include input fields 1252 and 1253 which the manager user can use to enter a title and a description for the to-be-added group skill, respectively. In one embodiment, UI 1250 may further include input fields 1254 which the administrator user can use to define each star level for the particular team skill to be created, thus providing clear guidance to raters in their respective rating of performance of a team member (ratee) on the particular team skill UI 1250 further includes a “Submit” button 1251, clicking of which causes an action request to add a group skill to be submitted to backend system 102 along with group skill data which the manager user submitted through input UI elements included in UI 1250 (such as input fields 1252 and 1253).

Receiving of the action request by backend system 102 triggers a process of handling the action request exemplified by blocks illustrated FIGS. 6B, 6C and 6D. In particular, with respect to block 621, group-related submission processor 325 may be invoked to process the action request to add a group skill to the featured group. With respect to block 623, group-related submission processor 324 may call group skill model component 423 to create one or more new data records (reflecting the addition of a group skill to the featured group) and store the user-submitted group skill data corresponding to the newly added group skill, in one or more component data stores of DS 111 (such as group skill DS 222), so as to effectuate the creation of a new group skill for the featured group.

The removal of an existing group skill from the group skill list of the featured group (as triggered by the clicking of icon 1243, or the editing of an existing group skill (such as editing the skill description), may be materialized with implementations similar to what has been described above in connection with adding a group skill, except the one or more component data stores of DS 111 (such as group skill DS 223) are updated to reflect either the removal of an existing group skill or one or more changes made to an existing group skill

FIGS. 12H-I illustrate exemplary UIs which the disclosed skill-rating system may provide to let a user view, participate and create group discussions. FIG. 12I show an exemplary section UI 1271 which the disclosed skill-rating system may provide to enable a user to view, participate, and create group discussions. Section UI 1271 may be the main viewing area of group tab panel 1221 when the “Discussion” tab is selected as the active tab of group tab panel 1221.

In particular, FIG. 12H shows a first view of discussion tab UI 1271. As shown, in the first view, discussion tab UI 1271 may include a list of sub-panel 1272 each dedicating to an existing group discussion and providing a condensed or summary view of the dedicated discussion. Each sub-panel 1272 may include clickable subject link 1273 showing the subject of the underlying discussion, text item 1274 showing the description of the underlying discussion, status item 1275 indicating the latest status of the underlying discussion, and text item 1276 indicating the number of replies received for the underlying discussion.

FIG. 12I shows a second view of discussion tab UI 1271. As shown, the second view is dedicated to a particular discussion selected by the user by, e.g., clicking subject link 1273. In the second view, details of the dedicated discussion are shown, including one or more replies received for the discussion. Specifically, discussion tab UI 1271 may include a lead subpanel 1277 (summarizing the discussion by listing the subject, description and latest status of the dedicated discussion), one or more follow-up reply sub-panel 1278 each showing information about a reply to the discussion, and a comment-posting sub-panel 1280 including input field 1280 and “Add comment” button 1281 for posting a new reply to the featured discussion. Further, discussion tab UI 1271 may include clickable link 1283 for creating a new discussion and clickable link 1284 for viewing all discussions. In one embodiment, clicking link 1284 results in discussion tab UI 1271 switching from the second view to the first view (showing a list of subpanels 1272 each for a group discussion).

The provision of discussion tab UI 1271 may be implemented in a manner similar to what has been described with respect to the implementation of the provision of bulletin tab UI 1261 or skill table UI 1241 with exceptions in data list components and dynamic viewer components called. In particular, with respect to block 624, group-related data request processor 346 may call group discussion list component 465 to retrieve for display discussion data (including discussions and replies) for the featured group. Additionally, with respect to block 632 of FIG. 6D, group discussion list viewer component 585 of display engine 122 may be called to generate UI instructions to render discussion tab UI 1271.

FIG. 12J shows an exemplary UI 1290 through which a user of a group can create a new group discussion. The exemplary UI 1290 may be displayed as a result of the user clicking link 1283 of discussion tab UI 1271. Specifically, UI 1290 may include input fields 1291 and 1292 for entering the subject and description (message) of a to-be-created team discussion, respectively. UI 1290 may further include a “Save” button 1293.

For UI 1290, clicking of “Save” button 1293 causes an action request to create a group discussion to be submitted to backend system 102 along with data associated with the action request. For discussion tab UI 1271, clicking of “Add comment” button 1281 causes an action request to add a reply comment (to a group discussion) to be submitted to backend system 102 along with data associated with the action request. For either action request, the data submitted with the action request may include input data (such as data entered through input fields 1280 or fields 1291 and 1292). The submitted data may also include group-identifying data, which may be provided via discussion tab UI 1271 and visually hidden in UI 1290. For the action request to add a reply comment, the submitted data may further include discussion-identifying data provided via discussion tab UI 1271.

Receiving of either action request by backend system 102 triggers a process of handling the action request exemplified by blocks illustrated FIGS. 6B, 6C and 6D. In particular, with respect to block 621, group-related submission processor 325 may be invoked to process the received action request. With respect to block 623, group-related submission processor 325 may call group discussion model component 425 to create one or more new data records (reflecting the addition of a new group discussion or a new reply to an existing group discussion) and store the user-submitted data corresponding to either the newly added group discussion or the newly added reply to a group discussion, in one or more component data stores of DS 111 (such as group discussion DS 222), so as to effectuate the creation of a new group discussion or a new reply to a group discussion for the featured group. To update or refresh discussion tab UI 1271 (so as to reflect the addition of a new reply to a featured group discussion), with respect to block 624, group discussion list component 465 of data engine 122 may be called to retrieve for display updated discussion data (including discussions and replies) for the featured group. Additionally, with respect to block 632 of FIG. 6D, group discussion list viewer component 585 of display engine 123 may be called to generate UI instructions to render the updated or refreshed discussion tab UI 1271.

FIG. 12K shows an exemplary UI which the disclosed skill-rating system may provide to let an administrator user to view and manage members of a group. FIG. 12K show an exemplary section UI 1222 which the disclosed skill-rating system may provide to enable an administrator user to view and manage members of a group. Section UI 1222 (hereinafter referred to as “member tab UI 1222”) may be provided in the main viewing area of group tab panel 1221 when the “Member” tab is selected as the active tab of group tab panel 1221.

As shown, member tab UI 1222 comprises a list of sub-panels 1223 each for a member user of the group. Each sub-panel 1223 comprises clickable links 1288 that allow the user to view rater information and rating information of a member user (for which the sub-panel is listed) in manners similar to those respectively illustrated in FIGS. 15-16. Also, each sub-panel 1223 may comprise clickable link 1602A that allows the user to view skill-charts-over-time on group-skills (as will be illustrated in FIGS. 16A-K). Additionally, each sub-panel 1222 comprises a clickable “Remove” button 1225 for removing from the featured group the member user for which the sub-panel is listed, and clickable buttons 1287 and 1286 for setting and removing the administrative role of member users.

The provision of member tab UI 1222 may be implemented in a manner similar to what has been described with respect to the implementation of the provision of bulletin tab UI 1261 or skill table UI 1241 with exceptions in data list components and dynamic viewer components called. With respect to blocks 624 of FIG. 6C, group-related data request processor 346 may call group member list component 462 to retrieve for display member data for the particular group. With respect to block 632 of FIG. 6D, group member list viewer component 582 of display engine 122 may be called to generate UI instructions to render member tab UI 1222.

FIG. 12L shows exemplary UIs which the disclosed skill-rating system may provide to let an administrator user to view statics relating to a group (team). These UIs may be displayed resulting from a clicking of UI link 1228 (shown in FIG. 12C).

FIGS. 13A-I collectively illustrate exemplary UIs as well as processing blocks that the disclosed skill-rating system may use to implement a group-based rating request used to receive rating data on group skills for individual members of a group, according to one or more embodiments of the present disclosure.

For each group, the disclosed skill-rating system may enable one or more members of the group to create a special group-based rating request used to solicit, collect, or receive ratings of group members on one or more group-skills of the group. In one implementation, such a group-based rating request is named “AnyTime 360 Request”, referring to the fact that such a group-based rating request may be created or otherwise issued at any time and designed to receive ratings (on group-skills) from users having different relationships to a group member (to which the group-based rating request is directed). In one embodiment, only a group administrator is allowed to create or otherwise issue such a group-based rating request.

In one embodiment, once such a group-based rating request is issued, the group-based rating request is automatically sent to or otherwise provided to every group member except the group member issuing the rating request, as target users. In one embodiment, the group-based rating request may be sent to or otherwise provided to group members of the issuing group member's choice, as target users. So, in that embodiment, the disclosed skill-rating system may provide one or more UIs to enable the issuing group member (e.g., a group administrator) to select group members (to which the group-based rating request is issued) as target users. The selected group members (target users) may include the issuing group member himself/herself. Hereinafter, for the ease of discussion, such a group-based rating request will simply be referred to as a “team-360-request.”

Referring to FIG. 13A, for each group, the disclosed skill-rating system may provide, as part of group tab panel 1221, a special “Anytime 360 Request” tab dedicated to team-360-requests of the group. As shown, when the “Anytime 360 Request” tab is selected, UI 1301 (hereinafter referred to as “team-360-request tab UI 1301”) is provided in the main viewing area of group tab panel 1221. As shown, in this example, team-360-request tab UI 1301 comprises a plurality of team-360-request subpanels 1302 each dedicated to an issued team-360-request. Each team-360-request subpanel 1302 comprises UI element 1305 identifying the dedicated team-360-request.

Each team-360-request subpanel 1302 may further comprise actionable (clickable) UI elements 1304, each of which, when clicked, results in a specific action request being sent to backend system 102 and the team-360-request subpanel being expanded to include additional UI elements provided and displayed in response to the sent action request and containing information and data sought for by the sent action request. For example, clicking actionable UI link 1304A may result in summary or detail rating data of associated group members on the team-360-request being displayed; clicking actionable UI link 1304B may result in a specific UI being displayed to enable the issuing team administrator to request a re-rate on the team-360-request; and clicking UI link 1304C may result in a statistics report about the team-360-request being either directly presented (displayed) or indirectly provided (via, e.g., a link which can be used to download the statistics report).

FIG. 13B is a flowchart illustrating a control flow of how a team-360-request can be used to solicit, collect, or otherwise receive ratings of group members on group skills in reference to a reference group (team) activity.

At block 1321, UIs are displayed or otherwise provided (by either backend system 102 or client device 101) to enable a group member (such as a group administrator) to create or otherwise issue a team-360-request. As one example, referring to FIG. 13A, a clickable UI button 1303 is provided on the team-360-request tab UI 1301 to launch a UI specifically provided for creating or otherwise issuing a new team-360-request. More specifically, in one implementation, clicking UI button 1303 results in an action request to create a new team-360-request being sent to either backend system 102 or the hosting client device 101. A UI specifically provided to create or otherwise issue a new team-360-request is subsequently displayed or otherwise provided on the hosting client device 101. Block 1321 may be implemented by blocks 601-603 of FIG. 6A.

FIG. 13C illustrates an example of such a team-360-request creation UI, namely team-360-request creation UI 1330. As shown, UI 1330 is similar to rating request creation UI 1100 shown in FIG. 11B for creating a normal rating request. For example, similar to UI 1100, UI 1330 includes a section UI 1331 configured to let the request-issuer define a reference activity. A reference activity defined through section UI 331 is presumably one specifically relating to the underlying group (team). Thus, the reference activity of a typical team-360-request may be referred to as a “group reference activity” (or “team reference activity”) or a “group activity” (or “team activity”). There are also a few notable differences between UI 1330 and UI 1100. First, unlike UI 1100, the skill selector 1331 of team-360-request creation UI 1330 is configured to only list group skills of the featured group, thus only allowing group skills of the featured (underlying) group to be selected for the team-360-request.

Second, in one implementation, team-360-request creation UI 1330 does not include any UI element for selecting raters, such as rater selector 1000 included in UI 1100. This is because, in this implementation, the created team-360-request would be by default automatically provided to all group members (as target users) except the request-issuing group member. Of course, in a different embodiment where a team-360-request can be configured to be provided to a custom subset of group members and/or non-member users (as target users), a rater selector UI element may be included in team-360-request creation UI 1330 to enable the request-issuing group member (request-issuer) to select a custom subset of group members and/or even non-member users.

Third, in one implementation, team-360-request creation UI 1330 may include a different set of visibility settings from that of UI 1100. As shown, UI 1330 may comprise a privacy setting selector 1334, which is configured to let the request-issuer to select a privacy setting out of privacy settings that include “Public” (or one of similar nature), “Raters Cannot be Seen By Team Members” (or one of similar nature), “Team Members Cannot View Ratings” (or one of similar nature), and “Team Members Cannot See Each Other” (or one of similar nature).

These differences between UI 1330 and UI 1100 reflect differences between a team-360-request and a normal rating request. The former is rating request tailored to a specific group, whereas the latter is tailored to a specific user himself/herself. To distinguish between a team-360-request and a normal rating request, the latter may hereinafter be also referred to as a “user rating request.”

At block 1322, after the request-issuing group member submits an action request to issue a created team-360-request to backend system 102 (via, e.g. the submit button 1335 of UI 1330), backend system 102 performs custom processing on the submitted action request (as part of, e.g., block 622 of FIG. 6C). More specifically, backend system 102 may send or otherwise provide the created team-360-request to the target users. As noted above, the target users may be exclusively member users of the featured group, which may either be selected by default or selected by manual selection made via UI 1330. Alternately or additionally, the target users may also include users who are not members of the featured group.

The sending or the providing of the team-360-request may be implemented or otherwise materialized in the form of “dropping” a related notification in the account of each of the target users, with the notification notifying the account holder (user) of the pending the team-360-request. Optionally, the sending of the team-360-request may include sending each target user an e-mail informing of the team-360-request and including a hyperlink which the target user can use to rate on or otherwise respond to the team-360-request. A target user (e.g., a group member) then sees the notification (as exemplified by notification icon 824C) when the target user logs into his/her account. Upon clicking notification icon 824C, the selected group member may be presented a UI specifically provided to inform him/her about the team-360-request and enable him/her to answer or otherwise respond to the team-360-request. FIG. 13D illustrates an example of such a UI, namely pending team rating notification UI 1341.

At block 1323, for each target user, one or more UIs are displayed or otherwise provided to enable the target user to answer or otherwise respond to the notified team-360-request by, e.g., performing self-rating on the featured team-360-request as well as inviting other users (raters) to rate the target user on the featured team-360-request. Referring to FIG. 13D again, clicking of the “Rate Now” button 1342 results in UI 1350 being displayed to enable the target user to answer or otherwise respond to the notified team-360-request. Thus, the target user may now be referred to as the answering user, and UI 1350 may be hereinafter referred to as “team-360-request answering UI 1350” or simply “answering UI 1350.”

The team-360-request answering UI 1350 may comprise UI element 1351 identifying the team-360-request as well as UI element 1352 identifying the privacy setting of the team-360-request. In one implementation, the team-360-request answering UI 1350 is specifically configured to let the answering user (who, e.g., is a group member) perform self-rating on the one or more group skills included in the team-360-request in reference to the team activity defined (or otherwise referenced) in the team-360-request. Thus, the team-360-request answering UI 1350 may comprise section UI 1353 configured to let the answering user perform self-rating on the one or more group skills in reference to the team activity.

Additionally or alternately, the team-360-request answering UI 1350 is specifically configured to let the answering user invite other users (potential raters) to rate the answering user on the one or more group skills in reference to the team activity. Thus, the team-360-request answering UI 1350 may comprise section UI 1354 configured to let the answering user invite other users to rate on the one or more group skills in reference to the team activity. In one embodiment, the invited users (potential raters) are not limited to group members of the underlying group, and thus may include users who are not members of the underlying group. Thus, section UI 1354 may be configured to enable the answering user to select potential raters from different social network sources, including social network sources other than the underlying group.

The answering user, upon completing the answering to the team-360-request with UI 1350, may submit the response (as provided in the UI 1350) to backend system 102 by clicking of the submit button 1355, resulting in backend system 102 receiving the answering user's response to the team-360-request.

In connection with the team-360-request, backend system 102 may derive or otherwise construct a matching (child) user rating request from the team-360-request. In one implementation, the reference activity of the derived (child) user rating request, text-wise, may be identical to or similar to that of the team reference activity of the parent team-360-request. The skills included in the child user rating request are the group-skills included in the parent team-360-request. The visibility setting of the child user rating request may be derived or otherwise set according to the privacy setting of the parent rating request such that the former is not inconsistent with the latter.

For each answering user, backend system 102 performs custom processing on the response to the team-360-request received from the answering user (as, e.g., part of block 622). As noted, the submission may include the answering user's self-rating data as well as the list of invited potential raters selected by the answering user. In performing the custom processing, the self-rating data may be stored as part of the 360-degree rating data on the one or more group skills (included in the team-360-request) in reference to the team activity of the team-360-request. Additionally, the backend system 102 sends or otherwise provides the constructed child user rating request to each of the invited potential raters as selected by the answering user via the answering UI 1350. From that point on, via the distributed child user rating request and subject to the privacy setting of the parent team-360-request, the answering user may receive his/her 360-degree ratings (feedback) on the group-skills (in reference to the team activity) from the invitee raters in same or similar manners as what have been illustrated in FIGS. 11E-F.

At block 1324, one or more re-rating requests for the same team-360-request may be issued from time to time as needed, so as to enable the request-issuer (or other team administrators) to collect progressive 360-degree ratings of target users over time on the same group-skills in reference to the same team activity. More specifically, if the underlying (reference) team activity lasts a non-trivial length of time, the disclosed skill-rating system provides “re-rating” means to enable the request-issuer (or other team administrators) to re-issue the same team-360-request to the target users (which, as noted, are typically group members), thus allowing the request-issuer (or other team administrators) to receive progressive 360-degree rating data of target users over time on the same group-skills (included in the team-360-request). The progress 360-degree rating data may indicate or otherwise reflect progress that target users may have made and demonstrated over the course of the underlying team activity. Such a process may be referred to as a re-rating of the team-360-request.

The re-rating may be initiated via clicking of UI link 1304B of the team-360-request (exemplified in FIG. 13A) and implemented through a re-rate request exemplified in FIGS. 13F-G. Referring to FIG. 13F, a re-rating UI 1360 may include a simple text input field 1361 configured to let a re-rating issuer enter a personalized message (as exemplified in FIG. 13F). Clicking the “Request Re-Rate” submit button 1362 results in an action request to re-rate the team-360-request being sent to backend system 102.

Upon receiving the action request to re-rate the team-360-request, backend system 102 performs, inter alia, the same or substantially similar custom processing which backend system 102 performs in block 1322 with respect to the team-360-request, except that backend system 102 realizes it is for re-rating for the team-360-request (rather than a first-time rating for the team-360-request) and thus notifies each target user accordingly. For example, in performing the custom processing, backend system 102 may, e.g., send each target user an e-mail informing of the re-rating request and including the personalized message provided by the re-rating issuer. Similarly, each target user of the team-360-request is notified of the request to re-rate on the same team-360-request through a notification UI similar to UI 1341 except that notification UI informs of a re-rating for the team-360-request.

For each target user, upon clicking of a same or similar “Rate Now” button 1342, a UI specifically configured to perform a re-rating of the team-360-request is displayed or otherwise provided on the target user's hosting client device 101. FIG. 13G illustrates an example of such a UI, namely, re-rating UI 1370. As shown, in one embodiment, re-rating UI 1370 is almost identical to answering UI 1350 (shown in FIG. 13E), except that the rater selector UI 1354 of re-rating UI 1370 is configured to automatically select the invitee raters previously selected by the target user for the same the team-360-request. In one embodiment, the rater selector UI 1354 of re-rating UI 1370 may be configured to allow the target user to change the invitee raters. In one embodiment, the rater selector UI 1354 of re-rating UI 1370 may be configured to fix the invitee raters to be the ones previously selected by the target user. As shown, through re-rating UI 1370, the target user is once again provided an opportunity to perform self-rating on the group-skills in reference to the same reference team activity. Since it is re-rating, the target user understands that the self-rating should be based on the target user's performance recently demonstrated presumably between the last time at which a self-rating is provided (on the same team-360-request) and this time (at which a self-rating is once again provided).

Clicking the “Request Re-rate” submit button 1355 results in the same or substantially similar custom processing which backend system 102 performs in block 1323 with respect to the child user rating request of the team-360-request, except that backend system 102 realizes it is for re-rating for the child user rating request (rather than a first-time rating for the child user rating request) and thus informs each invitee raters accordingly. As such, issuing re-rating request from time to time may allow the request-issuer (or other team administrators) to receive progressive 360-degree rating data of target users over time on the same group-skills in reference to successive time intervals (periods) of the same underlying reference team activity.

The disclosed skill-rating system provides means to show or otherwise provide to one or more group administrators of the underlying group the progressive 360-degree rating data of target users collected through the afore-demonstrated combination of first issuing a team-360-request and subsequently issuing one or more re-rating requests for the same team-360-request from time to time. Referring to FIG. 13H, clicking UI link 1304A of the team-360-request (shown in FIG. 13A) results in UI 1380 being provided to allow a group administrator to view progressive 360-degree rating data of target group members over time in a detailed manner. In particular, for each target group member who has responded to the team-360-request, UI 1380 includes a UI 1601 dedicated to the viewing of the progressive 360-degree rating data of the target group member. The viewing of the progressive 360-degree rating data through a UI 1601 will be further illustrated in FIGS. 16A-K. Thus, through UI 1380, a group administrator may view valuable progressive 360-degree rating data of each applicable target group member, thereby timely getting informed of the progress (or lack thereof) on the group-skills made by individual group members for the same reference team activity. Additionally, referring to FIG. 13I, clicking UI link 1304C of the team-360-request (shown in FIG. 13A) results in a statistic report of the team-360-request being provided to a requesting group administrator. As illustrated, the statistics report provides valuable rating data of applicable target group members on the group-skills collected through the issuing and the re-rating(s) of the team-360-request.

FIGS. 14A-C illustrate exemplary UIs which the disclosed skill-rating system provides to enable a user to view the user's skill data and used-for-skillrating activity data, according to one or more embodiments of the present disclosure.

FIG. 14A shows an exemplary section UI 1400 through which a user can view data about the user's skills and ratings on the user's skills. Referring to FIG. 14A, section UI 1400 may include a list of one or more skill panels 1401 each dedicated to displaying data about a featured skill, and a plurality of sorting links 1410 each for sorting or resorting the skill panel list based on a certain criterion (such as date, name, average rating, number of appreciations, and number of ratings).

As shown, each skill panel 1401 may include skill name text 1402 (which may be highlighted using a specific font, size and/or color) listing the name of the featured skill, a category text 1403 listing the name of the skill category to which the featured skill belongs to, description text 1404 listing the description of the featured skill, and rating indicator 1405 indicating the average rating of the skill Each skill panel 1401 may also include clickable icon 1406 for editing the featured skill and clickable “x” icon 1407 for removing the featured skill.

Each skill panel 1401 may further include clickable appreciation summary link 1408 (indicating the number of appreciations which the user has received for the featured skill), rating summary link 1409 (indicating the number of the ratings that the user has received for the featured skill as well as the number of activities from which the ratings have received), and skill-chart-over-time icon 1602A. Clicking appreciation summary link 1408 results in the hosting skill panel 1401 being expanded to include appreciation sub-panel 1412 showing a list of the appreciations which the user has received for the featured skill. Similarly, clicking rating summary link 1409 results in the hosting skill panel 1401 being expanded to include rating sub-panel 1411 showing a list of one or more activity-centered ratings which the user has received for the featured skill Additionally, clicking of skill-chart-over-time icon 1602A results in displaying a skill-chart-over-time showing progress (change) of the user's 360-degree ratings on the featured skill along a series of successive points in time on a time axis, as will be further exemplified below with reference to FIGS. 16A-K.

The provision of section UI 1400 may be implemented using the process and blocks illustrated in FIGS. 6B, 6C and 6D (in connection with handling an action request to request data). In particular, with respect to block 611 of FIG. 6B, the client application or backend system 102 may receive from the user an action request to view and access data about the skills of the user as a result of clicking the “My skills” link 821C. With respect to blocks 621 of FIG. 6C, skill data request processor 343 of processing engine 121 may be called to process the action request. With respect to blocks 624 of FIG. 6C, skill list component 447 of data engine 122 may be invoked to retrieve the requested skill list data for display. With respect to block 632 of FIG. 6D, skill list viewer component 563 of display engine 123 may be called to generate UI instructions to render section UI 1400.

Additionally, clicking either appreciation summary link 1408 or rating summary link 1409 may trigger client-side scripting code to send an asynchronous action request (along with associated data, such as data identifying an activity of a user) to request appreciation data or rating data, causing backend system 102 to process the action request using the process and blocks illustrated in FIGS. 6B, 6C and 6D. With respect to blocks 624 of FIG. 6C, rating list component 446 of data engine 122 may be invoked to retrieve the requested appreciation data or rating data for display. With respect to block 632 of FIG. 6D, rating list viewer component 565 of display engine 123 may be called to generate UI instructions to render appreciation subpanel 1412 or rating subpanel 1411.

Editing or removing the featured skill resulting from clicking icon 1406 or icon 1407 may be implemented in ways similar to what have been described with respect to adding a skill with reference to FIG. 9A or FIG. 9B. Specific to the implementation of editing or removing the featured skill, skill model component 407 of data engine 122 may be invoked to update or remove one or more data records corresponding to the featured skill of the user, rather than create one or more data records to reflect adding a skill

FIG. 14B shows an exemplary section UI 1420 through which a user can view data about the user's group skills and ratings on the user's group skills. As shown, section UI 1420 is similar to section UI 1400, except that each of a list of skill panels included in section UI 1420 is for a group skill of the user. Implementations of provision of section UI 1420 is also similar to the exemplary implementations of section UI 1420 described above, except that, for example, group data request processor 346, group-skill list component 463 and group-skill list viewer component 583 may be invoked during the processing of an action request to view and access data about the group skills of the user triggered by, e.g., clicking of “group-skill” tab 1421.

FIG. 14C illustrates an exemplary UI 1430 which the disclosed skill-rating system provides to enable a user to view the user's activity data. Referring to FIG. 14C, section UI 1430 may include a list of one or more activity panels 1431 each dedicated to displaying data about a featured activity, and a plurality of sorting links 1438 each for sorting or resorting the activity panel list based on a certain criterion (such as date, name, number of appreciations, and number of ratings).

As shown, each activity panel 1431 may include activity name text 1432 (which may be highlighted using a specific font, size and/or color) listing the name of the featured activity and description text 1433 listing the description of the featured activity. Each activity panel 1431 may further include clickable appreciation summary link 1434 indicating the number of appreciations which the user has received for the activity, and rating summary link 1435 indicating the number of the ratings of skills that the user has received for the activity. Clicking appreciation summary link 1434 results in the hosting activity panel 1431 being expanded to include appreciation sub-panel 1437 showing a list of the appreciations which the user has received for the activity. Similarly, clicking rating summary link 1435 results in the hosting activity panel 1431 being expanded to include rating sub-panel 1436 showing a list of one or more ratings of skills which the user has received for the activity.

The provision of section UI 1430 may be implemented in ways similar to what have been described with respect to an exemplary implementation of the provision of section UI 1400. Specific to the implementation of the provision of section UI 1430, activity data request processor 347, activity list component 444 and activity list viewer component 562 may be invoked during the processing of an action request to view and access data about the activities of the user triggered by, e.g., clicking of the “View all” link 852 of activity panel 817 of (home page 810).

Additionally, expanding an activity panel 1431 to include appreciation sub-panel 1437 or rating sub-panel 1436 as a result of clicking appreciation summary link 1434 or rating summary link 1435 may also be implemented in ways similar to what have been described with respect to implementing the expansion of a skill panel 1401 to include appreciation sub-panel 1412 or rating sub-panel 1411 as a result of clicking appreciation summary link 1408 or rating summary link 1409.

FIGS. 15A-B illustrates exemplary UIs which the disclosed skill-rating system may provide to enable a user to view data about a user's pending rating and rating on other users, according to one or more embodiments of the present disclosure.

FIG. 15A illustrates an exemplary UI which the disclosed skill-rating system provides to enable a user to view data about the user's pending ratings. A pending rating results from a rating invitee not responding to a received rating request. Referring to FIG. 15A, section UI 1500 may include a list of one or more pending rating panels 1501 each dedicated to displaying data about a featured pending rating. In one implementation, UI 1500 is displayed as a result of the user clicking drop-down menu item 871D of the user's home page 810 exemplified in FIG. 8K. As shown, each pending rating panel 1501 includes summary text 1504 providing summary information about the featured pending rating. Summary text 1504 may include user-name text 1502 (which may be highlighted using a specific font, size and/or color) listing the user name of the rating invitee from whom the awaited rating data is pending, and activity title text 1503 listing the title of the activity defined in the original rating request to which the pending rating results from.

Each pending rating panel 1501 may further include clickable “Reminder” stub 1505 for sending a reminder to the invitee user (via, e.g. e-mail), clickable “invite more” stub 1506 for inviting additional raters (using, e.g. rater selector 1000), and clickable “Details” stub 1507. In particular, clicking “Details” stub 1507 results in the hosting pending rating panel 1501 being expanded to include activity description text 1508 listing the description of the defined activity as well as skill list 1509 listing one or more skills included (for receiving respective ratings) in the original rating request.

The provision of section UI 1500 may be implemented in ways similar to what have been described with respect to an exemplary implementation of the provision of section UI 1300 or 1400. Specific to the implementation of the provision of section UI 1500, rating request data request processor 344, rating request list component 445 and rating request list viewer component 564 may be invoked during the processing of an action request to view and access data about the pending ratings of the user triggered by, e.g., clicking of the “My Ratings” link 821D of home page 810 followed by clicking of “My Pending Ratings” tab 1510.

Additionally, expanding a pending rating panel 1501 to include UI elements displaying additional activity information as a result of clicking “Details” stub 1507 may also be implemented in ways similar to what have been described with respect to implementing the expansion of a skill panel 1301 to include appreciation sub-panel 1312 or rating sub-panel 1311 as a result of clicking appreciation summary link 1308 or rating summary link 1309.

FIG. 15B illustrates an exemplary UI which the disclosed skill-rating system provides to enable a user to view data about the ratings (referred to hereinafter “outgoing ratings”) that the user has provided to other users, according to one or more embodiments of the present disclosure. Referring to FIG. 15B, section UI 1520 may include a list of one or more outgoing-rating panels 1521 each dedicated to displaying data about a featured outgoing rating instance. In one implementation, UI 1520 is displayed as a result of the user clicking drop-down menu item 871C of the user's home page 810 exemplified in FIG. 8K. As shown, each outgoing rating panel 1521 includes summary text 1524 providing summary information about the featured outgoing rating instance. Summary text 1524 may include user-name text 1522 (which may be highlighted using a specific font, size and/or color) listing the user name of the ratee user, and activity title text 1523 listing the title of the reference activity which the outgoing rating is based off.

Each outgoing-rating panel 1521 may further include clickable “Details” stub 1525. Clicking “Details” stub 1525 results in the hosting outgoing-rating panel 1521 being expanded to include rating sub-panel 1526 and comment sub-panel 1527. As shown, rating sub-panel 1526 may include, for the underlying rating instance, appreciation text 1526-A listing the appreciation which the user (rater) expressed to the ratee (in view of the ratee's performance demonstrated in the reference activity), rating block 1526-B listing the rater's ratings of target skills, and advice text 1526-C listing the advice which the rater provided to the ratee (in view of the ratee's performance demonstrated in the reference activity). Comment sub-panel 1527 may include “Show all” link 1527-A for showing all comments posted on the rating, comment block 1527-B showing either a first comment or all the comments posted on the rating, input field 1531 for providing text of a new comment, and “Post Comment” button 1532 for submitting the text of a new comment (entered via input field 1531).

FIGS. 16A-K illustrates exemplary UIs which the disclosed skill-rating system may provide to enable a user to view the user's 360-degree rating data indicating the user's progress on target skills over time, according to one or more embodiments of the present disclosure.

FIG. 16A illustrates an exemplary UI 1600 which the disclosed skill-rating system provides to enable a user to view data about the 360-degree ratings (referred to hereinafter “incoming ratings”) that the user has received from invitee raters of different relationships to the user (the inviting ratee). In one implementation, UI 1600 is displayed as a result of the user clicking UI drop-down menu item 871A of the user's home page 810 exemplified in FIG. 8K. UI 1600 may include a list of one or more incoming-rating panels 1601 each dedicated to displaying data about incoming ratings which are in reference to a reference activity defined (or otherwise referenced) in an underlying user rating request. From another perspective, each incoming rating panel 1601 is dedicated to a reference activity and uses the reference activity to show 360-degree incoming-rating data on a set of target skills included in the underlying user rating request.

As shown, each incoming rating panel 1601 includes UI elements 1607 identifying the reference activity defined in the user rating request. Each incoming-rating panel 1601 may also include clickable “Details” button 1603, which, when clicked, results in the hosting incoming-rating panel 1601 being expanded to display detailed rating data. Each incoming-rating panel 1601 may further include clickable actionable icons 1602, each of which, when clicked, results in the hosting incoming-rating panel 1601 being expanded to display a corresponding UI demonstrating one or more corresponding aspects of the user's incoming rating data relating to the reference activity. By way of example and not limitation, clicking icon 1602A results in displaying a skill-chart-over-time illustrating the user's progress ratings of target skills collected over a series of points in time at each of which either the underlying user rating request was issued or a re-rating of the underlying rating request was issued. Clicking icon 1602B results in displaying a series of spider charts each corresponding to a set of skill rating data collected a point in time at which either the underlying user rating request was issued or a re-rating of the underlying rating request was issued. Clicking icon 1602C results displaying a UI in which the user may post one or more comments responding to (or otherwise on) one or more instances of rating provided on the underlying rating request (or a re-rating of the underlying rating request). In one implementation, clicking icon 1602C results in displaying a UI where the detailed rating data on the underlying user rating request is listed. Clicking icon 1602D results in displaying a UI for inviting more invitee raters to rate on the underlying rating request. Clicking icon 1602E results in displaying a UI for issuing a re-rating request for the underlying user rating request. And clicking icon 1602F results in displaying a UI for archiving the received incoming rating data on the underlying user rating request.

FIGS. 16B-D illustrate exemplary UIs configured to display detailed rating data on the underlying user rating request to which an incoming rating panel 1601 is dedicated. Specifically, clicking UI button 1603 results in panel 1601 being expanded to include UI 1610 configured to display detailed rating data on the underlying rating request. In one implementation, as shown, UI 1610 is configured to group rating data, at a first level, by (a) rating data received from invitee raters and (b) self-rating data received from the user. UI 1610 is configured to further group rating data, at a second level (below the first level) by different request rounds of the underlying rating request. For the ease of the discussion, request round 1 of the underlying rating request refers to the initial (first) issuing of the underlying user rating request. Request round n of the underlying rating request refers to the (n−1)^{th} time issuing of rate-rating request of the underlying user rating request. Thus, request round 2 of the underlying rating request is the first time issuing of re-rating request, and request round 3 is the second time issuing of re-rating request.

To implement the first level of the two-level configuration, a tabbed UI 1611 is provided within UI 1610, with its first tab 1613A labeled “Feedback From Your Raters” and a second tab 1613B labeled “Self Rating”. The active tabbed UI 1611 corresponds to the tab 1613 that is currently (actively) selected. To implement the second level of the two-level configuration, a tabbed UI 1612 is provided within the active tabbed UI 1611, with each of its tabs 1614 labeled a request round number. The active tabbed UI 1612 corresponds to the request round number tab 1614 that is currently (actively) selected. In each active tabbed UI 1612, incoming rating data is listed one rating instance 1616 (as illustrated in FIG. 11F) after another, with rating data of (received from) each rating instance 1616 listed in a subpanel dedicated to the rating instance.

Thus, referring to FIG. 16B, when the first level “Feedback From Your Raters” tab 1613A is selected and the second level “Request #1” tab 1614A is selected, rating data of each of the three rating instances 1616 received from invitee raters in request round 1 (which is the initial issuing of the underlying rating request) are listed in the second level active tabbed UI 1612 (which is included in the first level active tabbed UI 1611). Referring to FIG. 16C, when the first level “Feedback From Your Raters” tab 1613A is selected and the second level “Request #2” tab 1614B is selected, rating data of each of the three rating instances 1616 received from invitee raters in request round 2 (which is the first time issuing of re-rating request of the underlying rating request) are listed in the second level active tabbed UI 1612.

Similarly, referring to FIG. 16D, when the first level “Self Rating” tab 1613B is selected and the second level “Request #1” tab 1614A is selected, rating data of the single rating instances 1616 received from the user's self-rating in request round 1 (which is the initial issuing of the underlying rating request) are listed in the second level active tabbed UI 1612. Notably, only second level “Request #1” tab 1614A is listed under the first level “Self Rating” tab 1613B. This indicates that the user chose not to provide self-rating for the first time issuing of re-rating request of the underlying rating request.

As noted, rating data of each rating instance 1616 is displayed in a subpanel dedicated to the rating instance. As shown, the displayed rating data includes appreciation text, the star rating provided to each applicable target skill included in the underlying user rating request, as well as advice text. Additionally, the displayed rating data may further include UI element 1615B identifying the selected visibility setting 1615B and UI element 1615A listing the time at which the rating was performed.

Thus, through the illustrated configuration of UI 1610 (configured to display detailed rating data), the user is able to navigate and drill down detailed 360-degree rating data collected over different points in time from raters of different relationships to the user on the user-selected target skills and in reference to the user-specified reference activity. In the example illustrated in FIGS. 16B-D, by navigating and drilling down detailed 360-degree rating data through UI 1610, it can be readily discovered that the user has made improvements on target skills over a period of time between the time at request round 1 and the time at request round 2. This is a feature that is however not available in the conventional skill-rating systems.

FIG. 16E illustrates an exemplary UI configured to display a skill-chart-over-time 1620 based on the skill rating data illustrated in FIGS. 16B-D. As illustrated, because the disclosed skill-rating system has the means to collect progressive rating data on a set of target skills over successive points in time, the exemplary skill-chart-over-time 1620 can be used to graphically represent the progressive rating data on the set of target skills. In one implementation, skill chart 1620 uses the x-axis to represent different points 1621 in time, at each of which either a rating request or a re-rating request of the rating request is issued (or, in other words, one request round of the underlying user rating request took place), and uses the y-axis to represent the star rating used to rate one or more target skills.

In one implementation, for each target skill, at each time point 1621 (which corresponds to a particular request round of the underlying user rating request), an average value of the received star ratings on the target skill corresponding to the time point is computed, and then plotted on the skill chart. Plotted points for the same target skill are successively connected to form line segments. To distinguish among different target skills, plotted points for a target skill may be drawn a symbol different from ones designated for other target skills. Alternately or additionally, line segments connecting plotted points for a target skill may be colored using a color different from those used for other target skills.

Thus, as illustrated, a skill-chart-over-time 1620 can illustrate how rating of one or more target skills progressed or otherwise changed over a series of successive points in time. For the rating example illustrated in FIGS. 16B-D, it can be readily discovered through the graphical representation of skill-chart-over-time 1620 that the user has made improvements on target skills over a period of time between the time at request round 1 and the time at request round 2. This is a feature that is however not available in the conventional skill-rating systems.

FIG. 16F illustrates an exemplary UI configured to display a series of spider charts 1630 generated based on the skill rating data illustrated in FIGS. 16B-D. As illustrated, each spider chart of the series of two spider charts 1630 is drawn based on multi-relationship 360-degree rating data on (collected through) a corresponding request round of the underlying user rating request.

As shown, each spider chart comprises a set of concentric circles, with each co-centric circle corresponding to a star rating value based on its radius. In one embodiment, the co-center corresponds to the lowest possible star rating value while the circle with the largest radius corresponds to the highest possible star rating value. The set of target skills subject to rating are designated to, or represented by, a corresponding set of concentric radial lines (radiating from the co-center) each intersecting each and every concentric circles. Thus, a rating of a target skill can be visually represented by a point on the radial line corresponding to the target skill To form a spider chart, for each relationship to the user, the set of rating points corresponding to the ratings of the set of respective target skills provided by the raters of the relationship to the user are connected to form a closed polygon by the series of segments each formed between two rating points on two respective neighboring radial lines. In one implementation, a rating point of a target skill as plotted on a spider chart is based on an average value of ratings (of the user) on the target skill given or otherwise provided by raters of a corresponding relationship to the user.

To visually distinguish ratings given by raters of different relationships to the user, rating points and segments may be drawn differently for raters of different relationships. In one implementation, different colors are used for segments drawn for raters of different relationships. In one implementation, different dot-dash patterns may be used for segments drawn for raters of different relationships. In one implementation, different-shaped symbols may be used for rating points for raters of different relationships. Thus, a spider chart provides an aggregate 360-degree graphical representation of ratings of respective target skills provided by raters of different relationships to the user.

Therefore, as illustrated, a series of spider charts 1630 can illustrate how ratings of one or more target skills given by raters of different relationships to the user progressed or otherwise changed over a series of successive points in time. For the rating example illustrated in FIGS. 16B-D, it can be readily discovered through the graphical representation of the illustrated series of spider charts 1630 that the user has made improvements on target skills over a period of time between the time at request round 1 and the time at request round 2. This is a feature that is however not available in the conventional skill-rating systems.

FIG. 16G illustrates an exemplary UI 1650 provided to enable the user to issue a re-rating request for an underlying user rating request. The issuing of one or more re-rating requests from time to time enables the user to receive ratings from invitee raters on a same or similar set of skills in reference to the same reference activity from time to time, thereby documenting the user's progress or change in ratings of the same or similar set of skills received from invitee raters. Implementations of issuing and answering re-rating request for an underlying user rating request are similar to the exemplary implementations of issuing and answering re-rating request for an underlying team-o-request illustrated in FIGS. 13F-G. In the exemplary UI 1650, UI 1652 is configured to fix the target skills to ones included in the underlying user rating request. In one embodiment, UI 1652 may be configured to enable the user to change target skills as needed. Also, in the exemplary UI 1650, UI 1653 is configured to fix the invitee raters to those initially selected in the underlying user rating request. In one embodiment, UI 1652 may be configured to enable the user to change invitee raters as needed.

FIG. 16H illustrate a series of two exemplary spider charts 1630-1 and 1630-2 corresponding to two separate user rating requests including a same set of target skills while issued at two different points in time, thereby illustrating the progress which the user has made on the 360-degree rating of the same set of target skills between the two different points in time. This example shows that the disclosed skill-rating system can be used to document progress on a same set of target skills or similar sets of target skills over time using a series of separate user rating requests respectively issued at a series of successive points in time.

FIG. 16I illustrate an exemplary UI 1640 which may be used to display 360-degree team rating data. Specifically, 360-degree team rating data may be grouped by skill-rating groups (teams). Under each group, the group's team-360-requests, which are used to collect 360-degree team rating data of the group, are listed in the form of a plurality of panels 1601 each dedicated to a specific team-360-request. As shown, a panel 1601 dedicated to a team-360-request may be configured similar to a panel dedicated to a user rating request. For each panel 1601, clicking of the “Detail” button 1603 results in detailed rating data for the team-360-request (to which the panel is dedicated) being displayed in a manner similar to the manner in which detailed rating data for a user-rating-request is displayed as illustrated in FIGS. 16B-F. Clicking of UI link 1602A results in a skill-chart-over-time 1620 being generated and displayed (in manners similar to those illustrated in FIG. 16E) based on the user's underlying 360-degree rating data on the group-skills at different points in time, as exemplified in FIG. 16J. Clicking of UI link 1602B results in a series of spider charts being generated and displayed (in manners similar to those illustrated in FIG. 16F) based on the user's underlying 360-degree rating data (on the group-skills) corresponding to different points in time at which the team-360-request and the re-rating requests of the same team-360-request were respectively issued, as exemplified in FIG. 16K.

FIGS. 17A-C illustrates exemplary UIs which the disclosed skill-rating system provides to enable a user to view follower and rater data as well as the user's own profile data, according to one or more embodiments of the present disclosure.

FIG. 17A shows an exemplary section UI 1700 through which a user can view follower data of the user. Referring to FIG. 17, section UI 1700 includes a list of one or more follower panels 1701 each dedicated to a featured follower or rater of the user. Each follower panel 1701 may include summary block 1707 of the featured follower or rater (which includes clickable image 1708 and clickable link 1709 showing a name of the follower or rater), clickable link 1706 for removing the follower or rater from the user's list of follower or rater, clickable link 1702 for viewing rating data of the follower or rater, and clickable link 1703 for viewing spider charts (360-degree feedback) of the follower or rater (if available).

As shown, clicking link 1702 results in the host follower panel being expanded to further include rating sub-panel 1704 (which is similar to the user's outgoing-rating sub-panel 1521 shown in FIG. 15B), through which the user may get more detailed rating data about the follower or rater. Similarly, clicking link 1703 results in the host follower panel being expanded to further include rating sub-panel 1705, through which the user can view spider charts each based on an activity of the follower or rater.

The provision of section UI 1700 may be implemented in ways similar to what have been described with respect to an exemplary implementation of the provision of section UI 1400. Specific to the implementation of the provision of section UI 1700, follower data request processor 342, rater/follower list component 443 and follower list viewer component 561 may be invoked during the processing of an action request to view and access data about the activities of the user triggered by, e.g., clicking of the “Followers” link 821A of (home page 810).

Additionally, expanding a follower panel 1701 to include additional UI elements displaying rating data or leading to viewing of spider charts as a result of clicking link 1702 or link 1703 may also be implemented in ways similar to what have been described with respect to implementing the expansion of a skill panel 1401 to include appreciation sub-panel 1412 or rating sub-panel 1411 as a result of clicking appreciation summary link 1408 or rating summary link 1409.

FIG. 17B shows an exemplary tabbed UI 1720 listing the profile data of a follower of the user. The displaying of UI 1720 may result from clicking one of the follower icons 1708 for the featured follower. As shown, the profile data of the featured follower is displayed in the main viewing area 1721 of UI 1720 when the “profile” tab is selected. Other skill-rating related data of the featured follower may be displayed in the main viewing area 1721 of UI 1720 when a corresponding tab—such as the “Followers” tab, the “Skills” tab, the “Groups” tab, and the “Activities” tab—is selected. Different types of skill-rating related data of a follower of the user may be displayed in manners similar to those in which corresponding types of skill-rating related data of the user are displayed as exemplified in FIGS. 14-16 (subject to the applicable visibility settings of the corresponding follower data).

Implementations of the provisions of UIs for the followers are similar to the exemplary implementations of the provision of corresponding UIs for the user described above in connection with FIGS. 8-16, with exceptions readily appreciated by a skilled artisan. As one example of those exceptions, component modules called during backend system 102's processing of an action request (to obtain a specific type of data of the follower) may take specific input parameters indicating that the action request is with respect to a specific follower or rater.

FIG. 17C shows an exemplary UI 1740 displaying the profile data of the user, according to one embodiment. As shown, raters are listed, which form a social network of the user for skill-rating purposes. The same or a similar follower panel 1701 may be used to display rater data of the user. Additionally, the user's skill data, activity data and rating data may be viewed or otherwise accessed through clicking or tapping the “Skill Card” button 1741.

FIGS. 18A-G illustrates exemplary UIs which the disclosed skill-rating system provides to enable a user to create one or more public rating requests, and receive and view ratings and feedbacks received from the public, according to one or more embodiments of the present disclosure.

In on embodiment, with the disclosed skill-rating system, only users having a premium membership may be allowed to create a pubic rating request. FIG. 18A shows an exemplary section UI 1800 through which a user can create a public rating request. In one embodiment, initially, section UI 1100 is displayed after the client application or backend system 102 receives a UI request for creating a rating request as a result of the user, e.g., clicking “Rating Request” link 822B (of home page 810). To create a public rating request, “public rating request” is selected via rating type selector 1101 as the desired type of rating request. Once the “public rating request” selection is made, section UI 1800 replaces section UI 1100 as the UI displayed for creating a rating request. In other words, the “public rating request” selection triggers section UI 1100 being replaced by section UI 1800. In another embodiment, a separate “Public Rating Request” link may be provided to cause section UI 1800 to be displayed directly for the user to make a public rating request. Referring to FIG. 18A, section UI 1800 is similar to section UI 1100 in terms of UI components. Comparing the two section UIs, rater selector 1000 and “Send Invitation” button 1110 of the latter are replaced by episode selector 1803, expiration date setter 1804 and “Create Vanity URL” button 1805 of the former. Other UI components of section UI 1100 remain mostly intact.

A public rating request is usually associated with a public or broadcast event or performance. Thus, a public or broadcast event or performance to a public rating request is an “activity” to a normal rating request. In other words, the user may use activity title input field 1102 and activity description input field 1103 to provide information about the subject public or broadcast event or performance. Hereinafter, “activity” and “event” or “performance” may be used interchangeably in connection with a public rating request.

Additionally, the request creator (or, in other words, the user) usually would like to receive rating and feedback from the public on different “aspects”, “features”, or “characteristics” of the subject event or performance. For a public rating request, skill selector 1104 can be used to select “aspects”, “features”, or “characteristics” on which the user would like to receive ratings or and feedbacks on. Thus, when used in the context of a public rating request, the term “skill” refers to any “aspect”, “feature”, or “characteristics” of a subject event or performance on which the user may receive rating and feedback.

With the disclosed skill-rating system, the user can use the “group skill” functionality to create “skills” intended to be included in the public rating request. Specifically, the user may, in advance, create a group and then create group skills of the group having the same, similar or corresponding names of the “skills” intended to be included in the public rating request. In one embodiment, the created group may correspond to one particular episode of a TV show or one particular public event, and thus may be only allowed to be associated with one public rating request. Then, to include the intended “skills” in the public rating request, the user may select the created “group skills” by first selecting the created group 1801 (after expanding “my group” 1113 in category pane 1105) in category pane 1105 and then selecting one or more created group skills 1802 listed in skill pane 1106 (as a result of the selection of the created group 1801 in category pane 1105).

In creating the public rating request, the user may use episode selector 1803 to select a specific episode of a TV show or a specific public event or performance. In one embodiment, the list of “episodes” available for selection through episode selector 1803 may be pre-defined. Additionally, the user may use expiration setter to set an expiration date for the public to provide feedback on the selected “skills” Similar to making a normal rating request, the user may use permission selector to select a permission setting, which defines who can see (or, in other words, the visibility level of) the received ratings.

Clicking “Create Vanity URL” causes an action request to create a public rating request to be sent to backend system 102 along with the rating request data provided via UI elements in section UI 1800. Receiving of the action request to create a public rating request by backend system 102 triggers a process of handling the action request. The process of handling the action request to create a public rating request is similar to the process of handling the action request to create a normal rating request. Specific to the handling of the action request to create a public rating request, there is no need to send any rating invitations. In particular, during the handling of the action request, a vanity URL address is generated and set up to allow the public to provide feedbacks on the “activity” specified in the public rating request and provide ratings on the “skills” specified (via skill selector 1105) in the public rating request based on how the “skills” are demonstrated in the specified “activity”.

Following the handling of the action request, in one embodiment, backend system 102 may provide a self-rating UI (via the client application) for the user to provide feedback and ratings (on the specified activity and skills) himself/herself. FIG. 18B illustrates an exemplary section UI 1820 for self-rating, which is similar to section UI 1140 (for answering a normal rating request). Specific to section UI 1820, section UI 1820 includes text 1821 which informs the user of the created vanity URL so that the user can publish the created vanity URL. Additionally, unlike section UI 1140, there is no relationship selector 1143, since the relationship (which is “self”) is already known.

The provision of section UI 1820 may be implemented using the process and blocks illustrated in FIGS. 6A and 6D (in connection with providing a UI in response to a UI request). In particular, with respect to block 601 of FIG. 6A, backend system 102 treats an action request to create a public rating request as a UI request for requesting self-rating UI. With respect to block 632 of FIG. 6D, rating provision UI component 525 of display engine 122 may be called to generate UI instructions to render section UI 1840.

The user may submit the user's self-rating data by clicking the “submit rating” button included in section UI 1820. The handling of the user's submission of self-rating data on the user's public rating request by backend system 102 is similar to what has been described above with respect to the handling of an invitee user's submission of rating data on a normal rating request.

FIG. 18C illustrates an exemplary section UI 1840 that the disclosed skill-rating system provides via the created vanity URL to allow a person in public to provide feedback on the specified “activity” and ratings on the specified “skills” Section UI 1840 is similar to section UI 1140 (for answering a normal rating request). Specific to section UI 1840, unlike relationship selector 1143 of section UI 1140, relationship selector 1841 list relationships from the standpoint of a person in public in relation to a public or broadcast event or performance. Thus, relationships available for selection via relationship selector 1841 may include “TV Viewer”, “Online Viewer”, “Audience Member”. Additionally, section UI 1840 provides input fields (such as input fields 1842 and 1843) for a public rater to provide name and contact information (such as name and e-mail address).

A public rater may submit feedback and rating data by clicking the “submit rating” button 1150 included in section UI 1840. The handling of the public rater's submission of feedback and rating on a public rating request by backend system 102 is similar to what has been described above with respect to the handling of an invitee user's submission of rating data on a normal rating request. Specific to the former, the public rater's name and contact info (as submitted via section UI 1840), rather than the invitee user's user ID, is stored in connection with the submitted rating. Additionally, with respect to block 632 of FIG. 6D, display engine 123 may generate UI instructions to render section UI 1860, as illustrated in FIG. 18D, as part of a “thank you” UI which is presented to the public rater following the public rater's rating data submission via section UI 1840.

FIG. 18E illustrates an exemplary section UI 1880 which the disclosed skill-rating system provides to enable a user to view the user's public rating data. Section UI 1880 is similar to section UI 1600 used for letting a user to view the user's rating data. Specific to section UI 1880, each rating panel 1881 shows vanity URL information via text 1882. Additionally, each rating panel 1881 shows episode information via text 1883.

Similar to incoming-rating UI 1601, clicking the “Detail” stub of a rating panel 1881 results in expansion of the rating panel 1881 to include detailed rating data. The number of ratings included in the rating panel 1881, however, may be much larger than the number of rating instances included in an incoming-rating UI 1601. FIG. 18F shows an exemplary rating panel 1881 expanded as a result of clicking of the “Detail” stub.

Similar to incoming-rating UI 1601, clicking the “Spider Chart” stub of rating panel 1881 results in displaying of a spider chart visually showing average rating by public raters of different types (different relationships), which are provided via relationship selector 1841 of section UI 1840.

Implementations of the provision of section UI 1880 are similar to what have been described above with respect to implementations of the provision of UI 1600. Specific to the former, if the received number of public ratings are large, rating list component 446 and rating list viewer component 565 may be specifically programmed and configured to retrieve and display a limited number of ratings each time the user requests for more rating data.

FIG. 18G illustrates two spider charts each generated based on public rating data received for a public rating request created for a specific public or broadcast event or performance. The upper chart is generated for a set of “skills” based on an earlier “activity” specified in an early public rating request. The lower chart is generated for the same set of “skills” based on a later “activity” specified in a later public rating requested. It is clear that that the lower chart shows better ratings on the same set of skills than the ratings on the same set of skills shown in the upper chart. Thus, the public rating request scheme can be a useful tool for the “public event” user to improve on a certain set of “skills” by letting them to conduct a series of progressive public rating request.

The blocks and steps described and the UI exemplified in connection with the embodiments disclosed herein and within the scope of the present disclosure can be embodied in one or more software modules executed by a processor. The one or more software modules can reside in one or more computer readable media. Such computer readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof.

1. A system of rating on skills of a user based on social-network of the user, the system comprising:
a registration means for enabling a user to perform registration so as to become a registered user;
a skill-rating social network means for forming a skill-rating social network of a registered user for facilitating skill-rating for the registered user;
a rating request means for creating rating requests by a registered requestor user, each of said created rating requests identified by an activity defining a context therefor, and each of said created rating requests including at least one skill on which a rating in regards to the registered requestor user is requested, and at least one invitee user selected through an invitee selection means;
the invitee selection means for enabling a registered user to select one or more invitee users from a plurality of networking platforms including the skill-rating social network of the registered user;
a rating means for receiving a rating request and answering the received rating request by a registered rater user, the rating means configured to enable the registered rater user to provide, in regards to a registered ratee user, rating on at least one skill of the received rating request in reference to the activity identifying the received rating request; and
a rating viewing means for enabling a registered ratee user to view, in respect to at least one rating request, ratings provided, in regards to the registered ratee user and on at least one skill included in the at least one rating request, by a plurality of registered rater users, the rating viewing means configured to enable the registered ratee user to view progress, over a period of time, of ratings provided, in regards to the registered ratee user, on at least one common skill of a series of rating requests created over the period of time.

2. The system of claim 1, wherein for the skill-rater social network means, the skill-rating social network of the registered user comprises registered rater users each of whom has provided, in regards to the registered user, rating on at least one skill of a rating request in reference to the activity identifying the rating request.

3. The system of claim 1, wherein for the invitee selection means, the plurality of networking platforms from which the registered user select one or more invitee users include at least one of an online social network and a web-based e-mail service.

4. The system of claim 1, wherein for the rating means, the registered rater user is the registered ratee user so that the registered ratee user provides, in regards to himself/herself, rating on the at least one skill of the received rating request in reference to the activity identifying the received rating request.

5. The system of claim 1, wherein the rating means is configured to enable the registered rater user to provide a piece of appreciation for the registered ratee user in reference to the activity identifying the received rating request.

6. The system of claim 1, wherein the rating means is configured to enable the registered rater user to provide a piece of advice for the registered ratee user in reference to the activity identifying the received rating request.

7. The system of claim 1, wherein the rating means is configured to enable the registered rater user to provide a resource URL for the registered ratee user in reference to the activity identifying the received rating request.

8. The system of claim 1, wherein the rating means is configured to enable the registered rater user to provide the information about a relation thereof to the registered ratee user in reference to the activity identifying the received rating request.

9. The system of claim 1, wherein for the rating means, the received rating request is created by the registered ratee user via the rating request means.

10. The system of claim 1, wherein the rating viewing means is configured to provide a 360-degree view, in respect to the at least one rating request, of ratings provided, in regards to the registered ratee user and on the at least one skill of the at least one rating request, by the plurality of registered rater users having different relations to the registered ratee user, and the rating viewing means is configured to provide at least one view showing the progress, over the period of time, of the ratings of the at least one common skill as provided in regards to the registered ratee user by the plurality of registered rater users having the different relations to the registered ratee user.

11. The system of claim 1, further comprising:
a skill-rating group means for creating one or more skill-rating groups for facilitating skill-rating and managing said created skill-rating groups, each said skill-rating group having a name, each said skill-rating group having at least one group-skill custom defined therefor, each said skill-rating group having a plurality of group members each being a registered user, and the plurality of group members including at least one administrator member having an authority to perform skill-rating related administrative tasks for the respective skill-rating group;

12. The system of claim 11, wherein the rating request means is configured to enable the registered requestor user to select at least one group-skill of one said skill-rating group of which the registered requestor user is a group member.

13. The system of claim 11, wherein the rating viewing means is configured to enable the registered ratee user to view ratings provided, in regards to the registered ratee user, on at last one group-skill of one said skill-rating group of which the registered ratee user is a group member.

14. The system of claim 13, wherein the skill-rating group means, for each said skill-rating group, comprises:
a group-skill means for defining, adding, and managing one or more group-skills of the respective skill-rating group;
a group member means for adding and managing group members of the respective skill-rating group; and
a group viewing means for viewing skill-rating related information about the respective skill-rating group.

15. The system of claim 14, wherein the group member means for each said skill-rating group, comprises:
a group member invitation means for inviting one or more invitee users to join the respective skill-rating group; and
a group member acceptance means for accepting a group member invitation to join the skill-rating group so as to become a group member of the respective skill-rating group.

16. The system of claim 14, wherein the group viewing means for each said skill-rating group, comprises:
a group member viewing means for viewing skill-rating related information of each group member of the respective skill-rating group;
a group-skill viewing means for viewing information about each group-skill of the respective skill-rating group;

17. The system of claim 16, wherein the group viewing means for each said skill-rating group, further comprises:
a group discussion viewing means for creating one or more discussions for the respective skill-rating group, enabling group members of the respective skill-rating group to participate each of the created discussions, and enabling group members of the respective skill-rating group to view contents of each of the created discussions;

18. The system of claim 16, wherein the group viewing means for each said skill-rating group, further comprises:
a group newsfeed viewing means for displaying real-time up-to-date newsfeed for the respective skill-rating group, and enabling group members of the respective skill-rating group to post comments on an item of the newsfeed for the respective skill-rating group;

19. The system of claim 1, further comprising:
a newsfeed viewing means for displaying real-time up-to-date newsfeed related to the skill-rating social network of a registered user.

20. The system of claim 1, further comprising:
a plurality of skill-rating notification means for notifying a registered user of one or more skill-rating related events that request attention or action of the registered user, at least one of the plurality of skill-rating notification means configured to trigger said rating means when the registered user acts on the respective skill-rating notification means.
